(19) United States
(12) Patent Application Publication
(10) Pub. No.: US 2014/0279141 A1
(43) Pub. Date: Sep. 18, 2014

(54) RECEIVING CONTENT IN ACCORDANCE WITH A PARTICULAR LEVEL OF ACCESS ASSOCIATED WITH A PARTICULAR AMOUNT OF CONTENT ACCESS LATENCY

(71) Applicant: Elwha LLC, Bellevue, WA (US)

(72) Inventors: Roderick A. Hyde, Redmond, WA (US); Royce A. Levien, Lexington, MA (US); Richard T. Lord, Tacoma, WA (US); Robert W. Lord, Seattle, WA (US); Mark A. Malamud, Seattle, WA (US); Tony S. Pan, Cambridge, MA (US); Lowell L. Wood, JR., Bellevue, WA (US)

(21) Appl. No.: 13/858,656

(22) Filed: Apr. 8, 2013

Related U.S. Application Data
(63) Continuation-in-part of application No. 13/854,203, filed on Apr. 1, 2013.
Application No. 13/854,203 is a continuation of application No. 13/853,706, filed on Mar. 29, 2013.
Application No. 13/853,706 is a continuation-in-part of application No. 13/795,612, filed on Mar. 12, 2013.

(51) Int. Cl. G06Q 30/08

(52) U.S. Cl. CPC G06Q 30/08
USPC 705/26.3

(57) ABSTRACT

Computationally implemented methods and systems include receiving a bidding tag for a content that is to be offered for consumption at different levels of access for accessing the content, the different levels of access for accessing the content to be offered being associated with different amounts of content access latencies and different amounts of associated fees, and the bidding tag to be received at least identifying a content type to be offered for consumption and designed for eliciting one or more bids for the content, transmitting a bid in response, at least in part, to receiving the bidding tag, the bid to be transmitted being a request for accessing the content at a particular level of access, the particular level of access being for accessing the content with a particular amount of content access latency and for a particular amount of associated fee, the particular level of access having been selected from the different levels of access for accessing the content; and receiving the content in accordance with the particular level of access. In addition to the foregoing, other aspects are described in the claims, drawings, and text.

If an Application Data Sheet (ADS) has been filed on the filing date of this application, it is incorporated by reference herein. Any applications claimed on the ADS for priority under 35 U.S.C. §§119, 120, 121, or 365(c), and any and all parent, grandparent, great-grandparent, etc. applications of such applications, are also incorporated by reference, including any priority claims made in those applications and any material incorporated by reference, to the extent such subject matter is not inconsistent herewith.

### CROSS-REFERENCE TO RELATED APPLICATIONS

The present application is related to and/or claims the benefit of the earliest available effective filing date(s) from the following listed application(s) (the “Priority Applications”), if any, listed below (e.g., claims earliest available priority dates for other than provisional patent applications or claims benefits under 35 USC §119(e) for provisional patent applications, for any and all parent, grandparent, great-grandparent, etc. applications of the Priority Application(s)). In addition, the present application is related to the “Related Applications,” if any, listed below.

### PRIORITY APPLICATIONS

The present application constitutes a continuation-in-part of U.S. patent application Ser. No. 13/795,612, entitled TIERED LATENCY OF ACCESS FOR CONTENT, naming Roderick A. Hyde; Royce A. Levien; Richard T. Lord; Robert W. Lord; Mark A. Malamud; Tony S. Pan; Lowell L. Wood, Jr. as inventors, filed 12 Mar. 2013 with attorney docket no. 0912-003-001-000000, which is currently co-pending or is an application of which a currently co-pending application is entitled to the benefit of the filing date.

The present application constitutes a continuation-in-part of U.S. patent application Ser. No. 13/854,203, entitled PROVIDING ACCESS TO CONTENT IN ACCORDANCE WITH A SELECTED LEVEL OF ACCESS FROM A PLURALITY OF GRADUATED LEVELS OF ACCESS, naming Roderick A. Hyde; Royce A. Levien; Richard T. Lord; Robert W. Lord; Mark A. Malamud; Tony S. Pan; Lowell L. Wood, Jr. as inventors, filed 1 Apr. 2013 with attorney docket no. 0912-003-002-000001, which is currently co-pending or is an application of which a currently co-pending application is entitled to the benefit of the filing date, and which is a continuation of U.S. patent application Ser. No. 13/853,706, entitled PROVIDING ACCESS TO CONTENT IN ACCORDANCE WITH A SELECTED LEVEL OF ACCESS FROM A PLURALITY OF GRADUATED LEVELS OF ACCESS, naming Roderick A. Hyde; Royce A. Levien; Richard T. Lord; Robert W. Lord; Mark A. Malamud; Tony S. Pan; Lowell L. Wood, Jr. as inventors, filed 29 Mar. 2013 with attorney docket no. 0912-003-002-000000.

### RELATED APPLICATIONS

### None

The United States Patent Office (USPTO) has published a notice to the effect that the USPTO's computer programs require that patent applicants reference both a serial number and indicate whether an application is a continuation, continuation-in-part, or divisional of a parent application. Stephen G. Kunin, Benefit of Prior-Filed Application, USPTO Official Gazette Mar. 18, 2003. The USPTO further has provided forms for the Application Data Sheet which allow automatic loading of bibliographic data but which require identification of each application as a continuation, continuation-in-part, or divisional of a parent application. The present Applicant Entity (hereinafter “Applicant”) has provided above a specific reference to the application(s) from which priority is being claimed as recited by statute. Applicant understands that the statute is unambiguous in its specific reference language and does not require either a serial number or any characterization, such as “continuation” or “continuation-in-part,” for claiming priority to U.S. patent applications. Notwithstanding the foregoing, Applicant understands that the USPTO's computer programs have certain data entry requirements, and hence Applicant has provided designation(s) of a relationship between the present application and its parent application(s) as set forth above and in any ADS filed in this application, but expressly points out that such designation(s) are not to be construed in any way as any type of commentary and/or admission as to whether or not the present application contains any new matter in addition to the matter of its parent application(s). If the listings of applications provided above are inconsistent with the listings provided via an ADS, it is the intent of the Applicant to claim priority to each application that appears in the Priority Applications section of the ADS and to each application that appears in the Priority Applications section of this application.

All subject matter of the Priority Applications and the Related Applications and of any and all parent, grandparent, great-grandparent, etc. applications of the Priority Applications and the Related Applications, including any priority claims, is incorporated herein by reference to the extent such subject matter is not inconsistent herewith.

Under the auspices of various alleged “rules” implementing the America Invents Act (AIA), the United States Patent and Trademark Office (USPTO) is purporting to require that an Attorney for a Client make various legal and/or factual statements/commentaries/admissions (e.g. Concerning any “Statement under 37 CFR 1.55 or 1.78 for AIA (First Inventor to File) Transition Application”) related to written description/new matter, and/or advise his Client to make such legal and/or factual statements/commentaries/admissions. Attorney expressly points out that the burden of both alleging that an application contains new matter with respect to its parent(s) and establishing a prima facie case of lack of written description under 35 U.S.C. §112, first paragraph lies firmly on the USPTO. Accordingly, and expressly in view of duties owed his client, Attorney further points out that the AIA legislation, while referencing the first to file, does not appear to constitute enabling legislation that would empower the USPTO to compel an Attorney to either make/advise such legal and/or factual statements/commentaries/admissions. Notwithstanding the foregoing, Attorney/Applicant understand that the USPTO's computer programs/personnel have certain data entry requirements, and hence Attorney/Applicant have provided a designation(s) of a relationship between the present application and its parent application(s) as set forth herein and in any ADS filed in this application, but expressly points out that such designation(s) are not to be construed in any way as any type of commentary and/or admission as to whether or not a claim in the present application is supported by a parent application, or whether or not the present application contains any new matter in addition to the matter of its parent application(s) in general and/or especially as such might relate to an effective filing date before, on, or after 16 Mar. 2013.

Insofar that the Attorney/Applicant may have made certain statements in view of practical data entry requirements of the USPTO should NOT be taken as an admission of any sort. Attorney/Applicant hereby reserves any and all rights to contest/contradict/confirm such statements at a later time. Furthermore, no waiver (legal, factual, or otherwise), implicit or explicit, is hereby intended (e.g., with respect to any statements/admissions made by the Attorney/Applicant in response to the purported requirements of the USPTO related to the relationship between the present application and parent application[s], and/or regarding new matter or alleged new matter relative to the parent application[s]). For example, although not expressly stated and possibly despite a designation of the present application as a continuation-in-part of a parent application, Attorney/Applicant may later assert that the present application or one or more of its claims do not contain any new matter in addition to the matter of its parent application[s], or vice versa.

### SUMMARY

In one or more various aspects, a method includes but is not limited to receiving a bidding tag for a content that is to be offered for consumption at different levels of access for accessing the content, the different levels of access for accessing the content to be offered being associated with different amounts of content access latencies and different amounts of associated fees, and the bidding tag to be received at least identifying a content type to be offered for consumption and designed for eliciting one or more bids for the content, transmitting a bid in response, at least in part, to receiving the bidding tag, the bid to be transmitted being a request for accessing the content at a particular level of access, the particular level of access being for accessing the content with a particular amount of content access latency and for a particular amount of associated fee, the particular level of access having been selected from the different levels of access for accessing the content; and receiving the content in accordance with the particular level of access. In some implementations, at least one of the registering, detecting, or displaying being performed by a machine or article of manufacture. In addition to the foregoing, other method aspects are described in the claims, drawings, and text forming a part of the disclosure set forth herein.

In one or more various aspects, one or more related systems may be implemented in machines, compositions of matter, or manufactures of systems, limited to patentable subject matter under 35 U.S.C. 101. The one or more related systems may include, but are not limited to, circuitry and/or programming for effecting the herein-referenced method aspects. The circuitry and/or programming may be virtually any combination of hardware, software, and/or firmware configured to effect the herein-referenced method aspects depending upon the design choices of the system designer, and limited to patentable subject matter under 35 USC 101.

In one or more various aspects, a system includes, but is not limited to, means for receiving a bidding tag for a content that is to be offered for consumption at different levels of access for accessing the content, the different levels of access for accessing the content to be offered being associated with different amounts of content access latencies and different amounts of associated fees, and the bidding tag to be received at least identifying a content type to be offered for consumption and designed for eliciting one or more bids for the content, means for transmitting a bid in response, at least in part, to receiving the bidding tag, the bid to be transmitted being a request for accessing the content at a particular level of access, the particular level of access being for accessing the content with a particular amount of content access latency and for a particular amount of associated fee, the particular level of access having been selected from the different levels of access for accessing the content, and means for receiving the content in accordance with the particular level of access. In addition to the foregoing, other system aspects are described in the claims, drawings, and text forming a part of the disclosure set forth herein.

In one or more various aspects, a system includes, but is not limited to, circuitry for receiving a bidding tag for a content that is to be offered for consumption at different levels of access for accessing the content, the different levels of access for accessing the content to be offered being associated with different amounts of content access latencies and different amounts of associated fees, and the bidding tag to be received at least identifying a content type to be offered for consumption and designed for eliciting one or more bids for the content, circuitry for transmitting a bid in response, at least in part, to receiving the bidding tag, the bid to be transmitted being a request for accessing the content at a particular level of access, the particular level of access being for accessing the content with a particular amount of content access latency and for a particular amount of associated fee, the particular level of access having been selected from the different levels of access for accessing the content, and circuitry for receiving the content in accordance with the particular level of access. In addition to the foregoing, other system aspects are described in the claims, drawings, and text forming a part of the disclosure set forth herein.

In one or more various aspects, a computer program product, comprising a signal bearing non-transitory storage medium, bearing one or more instructions including, but not limited to, receiving a bidding tag for a content that is to be offered for consumption at different levels of access for accessing the content, the different levels of access for accessing the content to be offered being associated with different amounts of content access latencies and different amounts of associated fees, and the bidding tag to be received at least identifying a content type to be offered for consumption and designed for eliciting one or more bids for the content, transmitting a bid in response, at least in part, to receiving the bidding tag, the bid to be transmitted being a request for accessing the content at a particular level of access, the particular level of access being for accessing the content with a particular amount of content access latency and for a particular amount of associated fee, the particular level of access having been selected from the different levels of access for accessing the content, and receiving the content in accordance with the particular level of access. In addition to the foregoing, other computer program product aspects are described in the claims, drawings, and text forming a part of the disclosure set forth herein.

In one or more various aspects, a system includes, but is not limited to a bidding tag acquiring module configured to acquire a bidding tag for a content that is to be offered for consumption at different levels of content access, each of the different levels of content access to be offered being associated with a different amount of content access latency and different amount of associated fee, and the bidding tag to be acquired at least identifying a content type to be offered for consumption and designed for eliciting one or more bids for the content; a bid relaying module configured to relay a bid that requests access to the content at a particular level of access, the relaying of the bid being in response, at least in part, to acquiring the bidding tag, the particular level of access being for accessing the content with a particular amount of content access latency and for a particular amount of associated fee, the particular level of access having been selected from the different levels of access for accessing the content; and a content obtaining module configured to obtain the content in accordance with the particular level of access as requested through the bid.

In addition to the foregoing, various other method and/or system and/or program product aspects are set forth and described in the teachings such as text (e.g., claims and/or detailed description) and/or drawings of the present disclosure.

The foregoing is a summary and thus may contain simplifications, generalizations, inclusions, and/or omissions of detail; consequently, those skilled in the art will appreciate that the summary is illustrative only and is NOT intended to be in any way limiting. Other aspects, features, and advantages of the devices and/or processes and/or other subject matter described herein will become apparent by reference to the detailed description, the corresponding drawings, and/or in the teachings set forth herein.

### BRIEF DESCRIPTION OF THE FIGURES

For a more complete understanding of embodiments, reference now is made to the following descriptions taken in connection with the accompanying drawings. The use of the same symbols in different drawings typically indicates similar or identical items, unless context dictates otherwise. The illustrative embodiments described in the detailed description, drawings, and claims are not meant to be limiting. Other embodiments may be utilized, and other changes may be made, without departing from the spirit or scope of the subject matter presented here.

FIG. 1 shows a high-level block diagram of a computing device 10* operating in a network environment.

FIGS. 2A, 2B, 2C, 2D, 2E, 2F, 2G and 2H show exemplary selection graphical user interfaces (GUIs) that may be displayed by the computing device 10* of FIG. 1.

FIGS. 2J, 2K, and 2M show exemplary visual presentations that may be displayed by the computing device 10* of FIG. 1.

FIG. 3A shows a block diagram of particular implementation of the computing device 10* of FIG. 1.

FIG. 3B shows a block diagram of another implementation of the computing device 10* of FIG. 1

FIG. 4A shows another perspective of the bidding tag acquiring module 102* of FIGS. 3A and 3B (e.g., the bidding tag acquiring module 102′ of FIG. 3A or the bidding tag acquiring module 102″ of FIG. 3B) in accordance with various implementations.

FIG. 4B shows the bid relaying module 104* of FIGS. 3A and 3B (e.g., the bid relaying module 104′ of FIG. 3A or the bid relaying module 104″ of FIG. 3B) in accordance with various implementations.

FIG. 4C shows the content obtaining module 106* of FIGS. 3A and 3B (e.g., the content obtaining module 106′ of FIG. 3A or the content obtaining module 106″ of FIG. 3B) in accordance with various implementations.

FIG. 5 is a high-level logic flowchart of a process, e.g., operational flow 500, according to some embodiments.

FIG. 6A is a high-level logic flowchart of a process depicting alternate implementations of the bidding tag receiving operation 502 of FIG. 5.

FIG. 6B is a high-level logic flowchart of a process depicting alternate implementations of the bidding tag receiving operation 502 of FIG. 5.

FIG. 6C is a high-level logic flowchart of a process depicting alternate implementations of the bidding tag receiving operation 502 of FIG. 5.

FIG. 6D is a high-level logic flowchart of a process depicting alternate implementations of the bidding tag receiving operation 502 of FIG. 5.

FIG. 6E is a high-level logic flowchart of a process depicting alternate implementations of the bidding tag receiving operation 502 of FIG. 5.

FIG. 6F is a high-level logic flowchart of a process depicting alternate implementations of the bidding tag receiving operation 502 of FIG. 5.

FIG. 6G is a high-level logic flowchart of a process depicting alternate implementations of the bidding tag receiving operation 502 of FIG. 5.

FIG. 6H is a high-level logic flowchart of a process depicting alternate implementations of the bidding tag receiving operation 502 of FIG. 5.

FIG. 7A is a high-level logic flowchart of a process depicting alternate implementations of the bid transmitting operation 504 of FIG. 5.

FIG. 7B is a high-level logic flowchart of a process depicting alternate implementations of the bid transmitting operation 504 of FIG. 5.

FIG. 7C is a high-level logic flowchart of a process depicting alternate implementations of the bid transmitting operation 504 of FIG. 5.

FIG. 7D is a high-level logic flowchart of a process depicting alternate implementations of the bid transmitting operation 504 of FIG. 5.

FIG. 7E is a high-level logic flowchart of a process depicting alternate implementations of the bid transmitting operation 504 of FIG. 5.

FIG. 8A is a high-level logic flowchart of a process depicting alternate implementations of the content receiving operation 506 of FIG. 5.

FIG. 8B is a high-level logic flowchart of a process depicting alternate implementations of the content receiving operation 506 of FIG. 5.

FIG. 8C is a high-level logic flowchart of a process depicting alternate implementations of the content receiving operation 506 of FIG. 5.

### DETAILED DESCRIPTION

In the following detailed description, reference is made to the accompanying drawings, which form a part hereof. In the drawings, similar symbols typically identify similar or identical components or items, unless context dictates otherwise. The illustrative embodiments described in the detailed description, drawings, and claims are not meant to be limiting. Other embodiments may be utilized, and other changes may be made, without departing from the spirit or scope of the subject matter presented here.

Throughout this application, examples and lists are given, with parentheses, the abbreviation “e.g.,” or both. Unless explicitly otherwise stated, these examples and lists are merely exemplary and are non-exhaustive. In most cases, it would be prohibitive to list every example and every combination. Thus, smaller, illustrative lists and examples are used, with focus on imparting understanding of the claim terms rather than limiting the scope of such terms.

In recent years, the rapid development of computing and networking technologies has fueled explosive growth in demand for content. The word “content” for purposes of this description may be in reference to any one or more of a wide variety of data/information that may be made available through today's computing and/or networking technologies. Some examples of content include news (e.g., business or financial news such as stock or commodities prices, celebrity news, agricultural news, sports news, and so forth), information provided through social media, consumable media such as movies, soundtracks, sporting events, and so forth.

As these technologies continue to evolve, consumers of such content (e.g., content consumers or simply “users”) are also demanding earlier and more timely access to content. For example, consumers of content in the financial or commodity industries are demanding increasingly earlier and earlier access to content (e.g., financial or market data such as stock or commodity prices). That is, early knowledge of certain financial/market/commodity information by, for example, institutional content consumers (e.g., banks, brokerage firms, etc.) may provide huge advantages for those institutional content consumers. Similarly, many everyday consumers of consumable media (e.g., movies, sports program, audio recordings, etc.) have a strong desire to access such consumable media as soon as such media becomes available.

It is also recognized that while some content consumers are willing to pay a large premium for early access to content; other content consumers may not be as willing to pay such a high premium for early access to the same content. It is further recognized that different content consumers will have different needs as to how soon they would like to access content and how much of a premium they would be willing to pay in order to get such content access. Accordingly, computationally-implemented systems and methods are provided herein that allows a content consumer to select earlier access to content by paying a higher fee, where the earlier the access to content the higher the corresponding or associated fee.

More particularly, the computational-implemented systems and methods to be described herein may be designed to receive or acquire a bidding tag for a content (e.g., news or consumable media) that is to be offered for consumption at different levels of access for accessing the content, the different levels of access for accessing the content to be offered being associated with different amounts of content access latencies and different amounts of associated fees, and the bidding tag to be received at least identifying a content type to be offered for consumption and designed for eliciting one or more bids for the content. The computational-implemented systems and methods may then be further designed to transmit or relay a bid in response, at least in part, to receiving the bidding tag, the bid to be transmitted being a request for accessing the content at a particular level of access, the particular level of access being for accessing the content with a particular amount of content access latency and for a particular amount of associated fee, the particular level of access having been selected from the different levels of access for accessing the content, and to receive or obtain the content in accordance with the particular level of access. In various implementations, the computational-implemented systems and methods may be implemented at a client device (e.g., an end user computer device such as a desktop, a laptop, a mobile device such as a Smartphone or a tablet computer, etc.).

Turning now to FIG. 1, which illustrates an example environment 100 in which the methods, systems, circuitry, and computer program products in accordance with various embodiments may be implemented at a computing device 10*. The computing device 10* may have any one of variety of form factors including, for example, a mobile computing device (e.g., a smartphone, a tablet computer, a laptop, and so forth), a desktop computer, a workstation, a dedicated terminal (e.g., Bloomberg terminal), and so forth. Note that FIGS. 3A and 3B illustrates block diagrams of two alternative implementations of the computing device 10* of FIG. 1. Note further that in the following, “*” represents a wildcard. Thus, references in the following description to, for example, “computing device 10*” may be in reference to the computing device 10′ of FIG. 3A or the computing device 10″ of FIG. 3B (as well as to the computing device 10* of FIG. 1).

In various embodiments, the computing device 10* may electronically communicate with one or more content sources 60 and/or one or more content aggregators 50 via one or more wireless and/or wired networks 5. A content source 60 may be any entity that can be the source for content. Examples of a content source 60 include, for example, Dow Jones, Nasdaq, Associated Press, Reuters, Bloomberg, New York Times, Twitter (e.g., a celebrity who uses Twitter or other social media such as Facebook, or a layperson providing any information of interest through social media), police or fire department communication channels, HBO, Warner Brothers, Columbia Pictures, NBC Universal, Walt Disney, and so forth.

In contrast, a content aggregator 50 is any entity that can aggregate and relay content to end users (e.g., content consumers). Examples of content aggregator 50 include, for example, Google, Yahoo, MSN, Huffington Post, MarketWatch, and so forth. Examples of the one or more wireless and/or wired networks 5 include for example, at least one of a local area network (LAN), a wireless local area network (WLAN), personal area network (PAN), Worldwide Interoperability for Microwave Access (WiMAX), public switched telephone network (PTSN), general packet radio service (GPRS), cellular networks including cellular data networks, and/or other types of communication networks.

In various embodiments, the computing device 10* may be designed to receive or acquire one or more bidding tags 30 from one or more content aggregators 50, from one or more content sources 60, and/or from one or more other network entities. The one or more bidding tags 30 that may be provided by these entities may be used in order to, for example, offer access to one or more content 20. For example, a bidding tag 30 may be used (e.g., transmitted) in order to elicit bids 40 (e.g., an order or a request for content access) from content consumers. In some cases, a bidding tag 30 may provide generic information related to a particular content 20 that is to be offered for access. In some instances, a bidding tag 30 may contain just enough information about a particular content 20 to make the particular content 20 identifiable (e.g., identifiable as a particular type of news or a particular movie) to a potential content consumer but without providing or disclosing the core component or components of the content 20 (e.g., core component of the content 20 that if revealed would render the content 20 essentially worthless). For example, if the particular content 20 to be offered access to is a movie, then the corresponding bidding tag 30 may include at least the title of the movie, and in some cases, additional data such as names of the cast and/or crew, movie trailer or trailers, and so forth. Further, the corresponding bidding tag 30 would generally not include the entire movie itself.

If the particular content 20 to be offered access to is, on the other hand, financial or market news, then the corresponding bidding tag 30 may merely identify the type of financial/market news (e.g., “Share price of ACME Corp. stocks on May 26, 2016) that is included in the content 20 without providing essential information (e.g., without providing the actual share price) related to the financial/market news. In yet another example, if the particular content 20 to be offered access to is news related to a particular celebrity, than the corresponding bidding tag 30 may indicate that the content 20 is “celebrity news” or may indicate the name of the celebrity without indicating what the news related to the celebrity is all about (e.g., the bidding tag 30 may indicate that the content 20 is news about “Lindsey Lohan” without identifying the specific news related to Lindsey Lohan). Thus, in various implementations, a bidding tag 30 for a particular content 20 to be offered access to may provide certain generic information related to the particular content 20 without providing core or essential data related to the particular content 20.

In response, at least in part, to receiving a bidding tag 30, the computing device 10* may be designed to visually present (e.g., display) a selection graphical user interface (selection GUI) for selecting a particular level of access for accessing content 20 from a plurality of graduated levels of access for accessing the content 20, the plurality of graduated levels of access for accessing the content 20 being for accessing the content 20 with varying amounts of latencies and for varying amounts of corresponding fees. In other words, the computing device 10* may be designed to present a particular type of GUI (which will be referred to herein as a selection GUI) that allows a user (e.g., content consumer) to select a particular level of access for accessing a particular content, the particular level of access that may be selected being associated with a particular amount of latency for accessing the content and for a particular amount of corresponding fee, the corresponding fee being greater for shorter latencies. Note that examples of selection GUIs that may be displayed by the computing device 10* of FIG. 1 are illustrated in FIGS. 2A, 2B, 2C, 2D, 2E, 2F, 2G, and 2H and which will be discussed in greater detail herein.

In some cases the word “latency,” as used herein, may be in reference to a time delay for accessing content, and more particularly, to an increment or interval of time between the earliest point in time that a particular content 20 is available for consumption and the point in time that the particular content 20 is actually made available or accessible. For example, in the case where the particular content 20 includes a feature length movie, the related latency for accessing such a content 20 may be the amount of time between when the movie is initially released in theaters and the point in time that the movie is actually made available through, for example the exemplary environment 100 of FIG. 1. In the case where the particular content 20 relates to a price of a particular stock, the related latency may be the amount of time between when the price is first available through, for example, Dow Jones or Nasdaq and when the price is actually made accessible or released through, for example the exemplary environment 100 of FIG. 1. In various implementations, the point in time in which the “latency clock” begins may not be relevant since the point in time that the latency clock begins can be completely arbitrary (e.g., could begin when a movie is initially released in theaters or some point in time afterwards). That is, the phrase “latency” as used herein relates to a time increment or interval. Thus, a more relevant aspect in accordance with these implementations may be the relevant amounts of latencies/fees associated with different levels of content access.

In response to the presentation of a selection GUI by the computing device 10* a content consumer (e.g., an end user) may select a particular level of content access to access content 20 that is associated with a particular level of latency and a particular corresponding or associated fee. In some implementations, in response to receiving the input (e.g., election of a particular level of content access with a particular level of latency/fee) from the content consumer, the computing device 10* may transmit at least one bid 40 (e.g., a request for content 20 for a particular amount of fee/latency) via the one or more wireless and/or wired networks 5. In various embodiments, the at least one bid 40 to be transmitted may be transmitted to one or more content sources 60, one or more content aggregators 50, and/or one or more other entities. In response to receiving a bid 40, a content source 60, a content aggregator 50, or another type of entity may transmit back to the computing device 10* the content 20 that was requested by the received bid 40.

In some implementations, the content 20 that is transmitted to the computing device 10* may be transmitted to the computing device 10* only after the latency that is associated with the agreed upon content access level (e.g., as agreed to through a transmitted bid 40) has lapsed. In other implementations, the content 20 may be transmitted to the computing device 10* prior to the agreed upon latency lapsing. In such situations, the computing device 10* may hold the received content 20, at least temporarily, and not release the received content 20 (e.g., not audibly or visually present the received content 20) until the agreed upon latency has lapsed.

In some implementations, the computing device 10* in addition to being able to receive a particular content 20 may also be designed to receive previous viewer information 22 and/or contextual data 24 from one or more content sources 60, one or more content aggregators 50, and/or one or more other entities. The previous viewer information 22 that may be acquired by the computing device 10* may provide various information related to users who may have previously viewed a particular content 20. For example, if a particular content consumer elects to receive a specific content 20 (e.g., content 20 that is related to the price of a particular stock on a particular date) one second (e.g., one second latency) following the initial release of the specific content 20, then the computing device 10* may be designed to receive previous viewer information 22 that indicates, for example, how many other content consumers have already previously accessed the content 20, the identities of those other content consumers who have already accessed the content 20, and/or how those other content consumers may have previously viewed the content 20 (e.g., the communication channels such as bandwidth of the communication channels that were used by the other content consumers in order to access the content 20). In some cases, such information may prove valuable to a content consumer (e.g., an institutional user such as a brokerage firm) receiving the content 20 when, for example, the content consumer is making business/financial decisions.

In some implementations, the previous viewer information 22 may be received by the computing device 10* at the same time or proximate to the point in time in which a bidding tag 30 is received by the computing device 10*. By providing such information to a content consumer, the content consumer may make a more informed decision as to whether to purchase the corresponding content 20 for a particular fee with a particular amount of latency. In other implementations, the previous viewer information 22 may be received by the computing device 10* at the same time or proximate to the point in time in which the content 20 is received by the computing device 10*.

As indicated above, in some implementations, the computing device 10* may be additionally or alternatively designed to receive contextual data 24 in addition to being designed to receive content 20. In various embodiments, contextual data 24 is data that provides information related to a particular content 20 and that may supplement the particular content 20. For example, if the content 20 that is to be received by the computing device 10* is financial/market news (e.g., price of a particular stock or commodity on a particular date) then the computing device 10* may be further designed to receive a corresponding contextual data 24 that provide historical financial/market data (e.g., historical prices of the particular stock or commodity). On the other hand, if the content 20 that is to be received by the computing device 10* is a consumable media such as a feature length movie, then the contextual data 24 that may be received by the computing device 10* may be one or more movie trailers that may be trailers for the movie or for another movie (e.g., another movie in the same genre). A more detailed discussion related to various aspects of the exemplary environment of FIG. 1 will be provided with respect to the processes and operations to be described herein.

Note that in the exemplary environment 100 of FIG. 1, the one or more content aggregators 50 may acquire or aggregate content 20 from other sources such as from one or more content sources 60. Thus, in FIG. 1, the one or more content aggregators 50 are illustrated as receiving one or more contents 20 as well as distributing the one or more contents 20.

Referring now to FIGS. 2A, 2B, 2C, 2D, 2E, 2F, 2G, and 2H, which illustrates exemplary selection GUIs that may be displayed by the computing device 10* of FIG. 1. In various embodiments, the exemplary selection GUIs may be for selecting a level of access for accessing content from a plurality of graduated levels of access for accessing the content, the selected level of access for accessing the content being associated with a particular amount of latency/corresponding fee. In various embodiments, the exemplary selection GUIs 200a, 200b, 200c, 200d, 200e, 200f, 200g, and 200h illustrated in FIGS. 2A, 2B, 2C, 2D, 2E, 2F, 2G, and 2H that may be generated by the computing device 10* may be based, at least in part, on bidding tags 30 received by the computing device 10*.

Turning particularly now to FIG. 2A, which illustrates a selection GUI 200a that may be generated by the computing device 10* in response, at least in part, to receiving a bidding tag 30. As illustrated, the selection GUI 200a may include a slider feature 201a for selecting a particular level of access for accessing a particular content 20 from a plurality of graduated levels of access for accessing the content 20 that are each associated with different amounts of latencies/associated fees, where higher fees are associated with lower latencies. The slider feature 201a includes a slider icon 202a that may be designed to be moveable along an elongated element 204a. The slider icon 202a may be moved along the elongated element 204a by a content consumer (e.g., an end user) by a variety of different means. For example, if the slider feature 201a is being displayed through a touchscreen then a content consumer may simply move the slider icon 202a by touching the slider icon 202a on the touchscreen with a finger and moving the slider icon 202a by sliding or “pushing” the slider icon 202a along the elongated element 204a being displayed on the touchscreen. Alternatively, a curser and a mouse may be used in order to move the slider icon 202a along the elongated element 204a.

The elongated element 204a having a first end 208a and a second end 210a, and the entire length of the elongated element 204a being divided into graduated levels of access for accessing a particular content 20 (e.g., Share price for ACME), the multiple graduated levels of access being represented at multiple points 212a along the elongated element 204a, and each level of access being associated with a different amount of latency and fee. Thus, in order for a content consumer to select a particular level of content access (with a particular amount of latency and a particular amount of associated fee), the content consumer slides the slider icon 202a until it is located at the desired position (which corresponds to a particular level of content access) along the elongated element 204a and then enters the access level selection by, for example, tapping or clicking the slider icon 202a or the “enter” icon 205a, or by other means for inputting the selection. As further illustrated in FIG. 2A, the selection GUI 200a may further include a content identifier 206a, an icon 207a for displaying a previous viewer information (e.g., information related to users who have previously accessed the content 20 including number of users who have already accessed the content, the identities of those users, and so forth), and icon 209a for displaying contextual information related to the content 20, which in this case is historical market data related to the content 20 (e.g., a price of a particular stock on a particular day) being offered for access. In various embodiments, icon 207a and/or icon 209a may be selected or activated by a content consumer by “tapping” or “clicking” these icons.

Note that the computing device 10* may be designed to generate the selection GUI 200a FIG. 2A (as well as the selection GUI 200b, 200c, 200d, 200e, 200f, 200g, or 200h of FIG. 2B, 2C, 2D, 2E, 2F, 2G, or 2H) based, at least in part, on data/information provided through a bidding tag 30 that may have been received by the computing device 10*. That is, in various implementations, the computing device 10* may be designed to receive and process a bidding tag 30 that provides certain information related to a particular content 20 to be offered for access. The information that is provided by the received bidding tag 30 may include, for example, the name or type of content 20 being offered for access, the various levels of latencies/fees available for selection by a content consumer, and so forth. In any event, such information may be used in order to construct a selection GUI 200a, 200b, 200c, 200d, 200e, 200f, 200g, or 200h of FIG. 2A, 2B, 2C, 2D, 2E, 2F, 2G, or 2H that may be displayed by the computing device 10*.

Referring now to FIG. 2B, which shows another exemplary selection GUI 200b that may be presented by the computing device 10* of FIG. 1 in response, at least in part, to receiving a bidding tag 40. As illustrated, the selection GUI 200b includes a plurality of icons 220b that may be clicked or tapped (e.g., tapped on a touch screen) in order to select a level of content access from a plurality of graduated levels of content access. As depicted, each of the illustrated icons may be associated with a different amount of latency (e.g., from zero weeks for the far left icon to 10 weeks to the far right icon). Each of the illustrated icons 220b being further associated with a different amount of associated fee (e.g., from $100 for the far left icon to $5 for the far right icon). Thus, each of the icons 220b associated with a different level of content access (e.g., graduated levels of latencies/fees—note that the latencies are inversely related to the fees such that the smaller the latency the higher the associated fee). As further illustrated in FIG. 2B, the selection GUI 200b may further include a content identifier 206b, which identifies the content 20 as being a feature movie with the title “Star Battle.” The selection GUI 200b is further illustrated as having an icon 207b for displaying/retrieving a movie trailer.

Referring to FIG. 2C, which illustrates another exemplary selection GUI 200c that may be presented by the computing device 10* of FIG. 1 in response, at least in part, to receiving a bidding tag 40. The selection GUI 200c, similar to the selection GUI 200a of FIG. 2A, includes a slider feature 201c that further includes a slider icon 202c and an elongated element 204c, the slider icon 202c being moveable along the elongated element 204c based on user input (e.g., user moving the slider icon 202c by sliding a finger along a touch screen or using a cursor to move the slider icon 202c). The different points along the entire length of the elongated element 204c being associated with different levels of access 212c to content 20, where each point along the elongated element 204c being associated with a different amount of latency (e.g., 1 minute, 1 second, 2 microsecond, etc.) and a different amount of fee (e.g., no fee, $10,000, $50,000, etc.). The selection GUI 200c, as further illustrated, includes a content identifier 206c and textual information 209c (which indicates information related to users who had previously accessed the content). Note that in alternative implementations, the textual information 209c may be replaced with an option (e.g., an option in the form of an icon) to display such textual information. In some cases, an end user may use the selection GUI 200c to select a level of content access by moving the slider icon 202c to the appropriate location (e.g., a location that is associated with the desired level of content access for a particular level of latency/fee) along the elongated element 204c and clicking or tapping icon 205c or the slider icon 202c.

FIG. 2D illustrates yet another selection GUI 200d that comprises a slider feature 201d and that may be presented by the computing device 10* of FIG. 1 in response, at least in part, to receiving a bidding tag 40. The slider feature 201d includes a slider icon 202d that is moveable along an elongated element 204d. The illustrated selection GUI 200d may be used by an end user (e.g., content consumer) for selecting an access level for accessing a consumable media, which in this case is a movie. The selection GUI 200d, as depicted, also includes a content identifier 206d and an icon 207d for retrieving/displaying a movie trailer associated with the movie. In some cases, an end user (e.g., content consumer) may use the selection GUI 200d to select a level of content access by moving the slider icon 202d to the appropriate location (e.g., a location that is associated with the desired level of content access for a particular level of latency/fee) along the elongated element 204d and clicking or tapping icon 205d or the slider icon 202d.

FIG. 2E illustrates yet another selection GUI 200e that comprises a slider feature 201e and that may be presented by the computing device 10* of FIG. 1 in response, at least in part, to receiving a bidding tag 40. The slider feature 201e includes a slider icon 202e that is moveable along an elongated element 204e. The illustrated selection GUI 200e may be used by an end user (e.g., content consumer) for selecting an access level for accessing news, which in this case is celebrity news. The selection GUI 200e, as depicted, also includes a content identifier 206e. In some cases, an end user (e.g., content consumer) may use the selection GUI 200e to select a level of content access by moving the slider icon 202e to the appropriate location (e.g., a location that is associated with the desired level of content access for a particular level of latency/fee) along the elongated element 204e and clicking or tapping icon 205e or the slider icon 202e.

FIG. 2F illustrates yet another selection GUI 200f that comprises a slider feature 201f and that may be presented by the computing device 10* of FIG. 1 in response, at least in part, to receiving a bidding tag 40. The slider feature 201f includes a slider icon 202f that is moveable along an elongated element 204f. The illustrated selection GUI 200f may be used by an end user (e.g., content consumer) for selecting an access level for accessing news, which in this case is celebrity news related specifically to Lindsey Lohan. The selection GUI 200f, as depicted, also includes a content identifier 206f, which identifies the content 20 as Lindsey Lohan news, does not identity the type of news (e.g., what type of news related to Lindsey Lohan) that is included in the content 20. In some cases, an end user (e.g., content consumer) may use the selection GUI 200f to select a level of content access by moving the slider icon 202f to the appropriate location (e.g., a location that is associated with the desired level of content access for a particular level of latency/fee) along the elongated element 204f and clicking or tapping icon 205f or the slider icon 202f.

FIG. 2G illustrates yet another selection GUI 200g that comprises a slider feature 201g and that may be presented by the computing device 10* of FIG. 1 in response, at least in part, to receiving a bidding tag 40. The slider feature 201g includes a slider icon 202g that is moveable along an elongated element 204g. Different points along the elongated element 204g being associated with different levels of access 212g to the content 20. The illustrated selection GUI 200g may be used by an end user (e.g., content consumer) for selecting an access level for accessing agricultural news, which in this case is a crop report. The selection GUI 200g, as depicted, also includes a content identifier 206g and previous user information 207g, which indicates information related to users who have previously accessed the content 20. In some cases, an end user (e.g., content consumer) may use the selection GUI 200g to select a level of content access by moving the slider icon 202g to the appropriate location (e.g., a location that is associated with the desired level of content access for a particular level of latency/fee) along the elongated element 204g and clicking or tapping icon 205g or the slider icon 202g.

FIG. 2H illustrates yet another selection GUI 200h that comprises a slider feature 201h and that may be presented by the computing device 10* of FIG. 1 in response, at least in part, to receiving a bidding tag 40. The slider feature 201h includes a slider icon 202h that is moveable along an elongated element 204h. The illustrated selection GUI 200h may be used by an end user (e.g., content consumer) for selecting an access level for accessing Federal Reserve news (e.g., news related interest rates). The selection GUI 200h, as depicted, also includes a content identifier 206h. In some cases, an end user (e.g., content consumer) may use the selection GUI 200h to select a level of content access by moving the slider icon 202h to the appropriate location (e.g., a location that is associated with the desired level of content access for a particular level of latency/fee) along the elongated element 204h and clicking or tapping icon 205h or the slider icon 202h.

Turning now to FIGS. 2J, 2K, and 2M that illustrates various exemplary visual presentations 250* for providing content 20 or that may be used for accessing content 20. In various embodiments, the example visual presentations 250* illustrated in FIGS. 2J, 2K, and 2M may be displayed by the computing device 10* after a particular amount of latency has lapsed (e.g., the amount of latency, which in some cases may be zero, that was selected using, for example, one of the selection GUI 200* illustrated in FIG. 2A, 2B, 2C, 2D, 2E, 2F, 2G, or 2H). Referring particularly now to FIG. 2J, which shows a visual presentation 250j that displays content 252 in the form of stock market news. The visual presentation 250j also includes previous user information 254 that provides information of one or more users (e.g., content consumers) who have previously accessed the content 20. As further illustrated in FIG. 2J, the visual presentation 250j may also include contextual data 256 in the form of historical market data (e.g., historical stock prices).

FIG. 2K illustrates a visual presentation 250k for accessing content 20, which in this case is a feature length movie (with the title of “The Godmother”). As shown, the visual presentation 250k may include a content identifier 206k and an icon 220k for retrieving and/or playing the movie. In order to retrieve and/or play the movie, the user may tap or click the icon 220k.

FIG. 2M illustrates a visual presentation 250m for access content 20, which in this case is celebrity news. As shown, the visual presentation 250m may include a content identifier 206m and a link 221m (e.g., a hyperlink) for retrieving and/or displaying the celebrity news. In order to retrieve and/or play the movie, the user may tap or click the link 221m.

Referring now to FIGS. 3A and 3B, illustrating two block diagrams representing two different implementations of computing device 10* of FIG. 1 and that can execute the operations and processes to be described herein. In particular, and as will be further described herein, FIG. 3A illustrates a computing device 10′ that is the “hardwired” or “hard” implementation of a system that can implement the operations and processes to be described herein. The computing device 10′ may include certain logic modules including, for example, a bidding tag acquiring module 102′, a bid relaying module 104′, a content obtaining module 106′, and/or a selection GUI providing module 108′ that are implemented using purely hardware or circuitry components (e.g., application specific integrated circuit or “ASIC”). In contrast, FIG. 3B illustrates a computing device 10″ that is the “soft” implementation of a system that can implement the operations and processes to be described herein. In various embodiments, the computing device 10″ may include certain logic modules including, for example, a bidding tag acquiring module 102″, a bid relaying module 104″, a content obtaining module 106″, and/or a selection GUI providing module 108″ that are implemented using electronic circuitry (e.g., one or more processors including one or more microprocessors, controllers, etc.) executing one or more programming instructions (e.g., software in the form of computer readable instructions 152—see FIG. 3B).

The embodiments of the computing device 10* illustrated in FIGS. 3A and 3B are two extreme implementations of a system in which all of the logic modules (e.g., the bidding tag acquiring module 102′, the bid relaying module 104′, the content obtaining module 106′, and the selection GUI providing module 108′) are implemented using purely hardware solutions (e.g., circuitry such as ASIC) as illustrated in FIG. 3A or in which all of the logic modules (e.g., the bidding tag acquiring module 102″, the bid relaying module 104″, the content obtaining module 106″, and the selection GUI providing module 108″) are implemented using software solutions (e.g., programmable instructions in the form of computer readable instructions 152 being executed by hardware such as one or more processors 116) as illustrated in FIG. 3B. Since there are many ways of combining hardware, software, and/or firmware in order to implement the various logic modules (e.g., the bidding tag acquiring module 102*, the bid relaying module 104*, the content obtaining module 106*, and the selection GUI providing module 108*), only the two extreme implementations (e.g., the purely hardware solution as illustrated in FIG. 3A and the software solution of FIG. 3B) are illustrated here. It should be noted here that with respect to the “soft” implementation illustrated in FIG. 3B, hardware in the form of circuitry such as one or more processors 116 are still needed in order to execute the software. Further details related to the two implementations of the computing device 10* illustrated in FIGS. 3A and 3B will be provided in greater detail below.

In some instances, one or more components may be referred to herein as “configured to,” “configured by,” “configurable to,” “operable/operative to,” “adapted/adaptable,” “able to,” “conformable/conformed to,” “designed to,” etc. Those skilled in the art will recognize that such terms (e.g., “configured to”) generally encompass active-state components and/or inactive-state components and/or standby-state components, unless context requires otherwise.

Referring particularly now to FIG. 3A, which illustrates a block diagram of an computing device 10′ that includes a bidding tag acquiring module 102′, a bid relaying module 104′, a content obtaining module 106′, a selection GUI providing module 108′, one or more processors 116 (e.g., one or more microprocessors), a memory 114, user interface 110 (e.g., a keyboard, a touchscreen, a microphone, and/or other user input/output devices), and/or a network interface 112 (e.g., a network interface card or “NIC”). In various embodiments, the memory 114 may store one or more applications 160 (e.g., an operating system (OS) 162, one or more browser applications 163, and/or one or more media player applications 164) and content 20. Although not depicted, the memory 114 may further include other types of applications not depicted in FIG. 3A including, for example, communication applications such as an email application and/or an instant messaging (IM) application.

In various embodiments, the bidding tag acquiring module 102′ of FIG. 3A is a logic module that may be designed to, among other things, acquire (e.g., receive) a bidding tag 30 for a content 20 that is to be offered for consumption at different levels of content access, each of the different levels of content access to be offered being associated with a different amount of content access latency and different amount of associated fee, and the bidding tag 30 to be acquired at least identifying a content type to be offered for consumption and designed for eliciting one or more bids 40 for the content 20. The bid relaying module 104′ of FIG. 3A is a logic module that may be configured to relay (e.g., transmit) a bid 40 that requests access to the content 20 at a particular level of access, the relaying of the bid 40 being in response, at least in part, to acquiring the bidding tag 30, the particular level of access being for accessing the content 20 with a particular amount of content access latency and for a particular amount of associated fee, the particular level of access having been selected from the different levels of access for accessing the content 20. In contrast, the content obtaining module 106′ of FIG. 3A is a logic module that may be configured to obtain the content 20 in accordance with the particular level of access as requested through the bid 40. The selection GUI providing module 108′, on the other hand, is a logic module that may be configured to generate a selection GUI (e.g., the selection GUI 200a of FIG. 2A or the selection GUI 200b of FIG. 2B) based, at least in part, on information/data provided through a bidding tag 30.

Turning now to FIG. 3B, which illustrates a block diagram of another computing device 10″ that can implement the operations and processes to be described herein. As indicated earlier, the computing device 10″ in FIG. 3B is merely the “soft” version of the computing device 10′ of FIG. 3A because the various logic modules: the bidding tag acquiring module 102″, the bid relaying module 104″, the content obtaining module 106″, and the selection GUI providing module 108″ are implemented using software and one or more processors 116 (e.g., one or more microprocessors or controllers) executing the software (e.g., computer readable instructions 152) rather than being implemented using purely hardware (e.g., ASIC) as was the case in the computing device 10′ of FIG. 3A. Thus, the bidding tag acquiring module 102″, the bid relaying module 104″, the content obtaining module 106″, and the selection GUI providing module 108″ of FIG. 3B may be designed to execute the same functions as the bidding tag acquiring module 102′, the bid relaying module 104′, the content obtaining module 106′, and the selection GUI providing module 108′ of FIG. 3A. The computing device 10″, as illustrated in FIG. 3B, may include other components (e.g., user interface 110, network interface 112, and so forth) that are the same or similar to the other components that may be included in the computing device 10′ of FIG. 3A. Note that in the embodiment of the computing device 10* illustrated in FIG. 3B, the various logic modules (e.g., the bidding tag acquiring module 102″, the bid relaying module 104″, the content obtaining module 106″, and the selection GUI providing module 108″) may be implemented by the one or more processors 116 (or other types of circuitry such as field programmable gate arrays or FPGAs) executing one or more computer readable instructions 152 stored in memory 114.

In various embodiments, the memory 114 of the computing device 10′ of FIG. 3A and the computing device 10″ of FIG. 3B may comprise of one or more of mass storage device, read-only memory (ROM), programmable read-only memory (PROM), erasable programmable read-only memory (EPROM), cache memory such as random access memory (RAM), flash memory, synchronous random access memory (SRAM), dynamic random access memory (DRAM), and/or other types of memory devices.

Turning now to FIG. 4A illustrating a particular implementation of the bidding tag acquiring module 102*(e.g., the bidding tag acquiring module 102′ or bidding tag acquiring module 102″) of FIGS. 3A and 3B. As illustrated, the bidding tag acquiring module 102* may include one or more sub-logic modules in various alternative implementations. For example, in various embodiments, the bidding tag acquiring module 102* may include a selection GUI data acquiring module 402, an access level identifying data acquiring module 404, a formula data acquiring module 406, a latency data and fee formula data acquiring module 408, a fee data and latency formula data acquiring module 410, a contextual information acquiring module 412, and/or a previous consumer information acquiring module 414. Specific details related to the bidding tag acquiring module 102* as well as the above-described sub-modules of the bidding tag acquiring module 102* will be provided below with respect to the operations and processes to be described herein.

FIG. 4B illustrates a particular implementation of the bid relaying module 104*(e.g., the bid relaying module 104′ or the bid relaying module 104″) of FIG. 3A or 3B. As illustrated, the bid relaying module 104* in various alternative embodiments may include one or more sub-logic modules including a user entry responsive bid relaying module 416, a contextual information request relaying module 418, and/or a previous consumer information request relaying module 420. Specific details related to the bid relaying module 104*, as well as the above-described sub-modules of the bid relaying module 104*, will be provided below with respect to the operations and processes to be described herein.

FIG. 4C illustrates a particular implementation of the content obtaining module 106*(e.g., the content obtaining module 106′ or the content obtaining module 106″) of FIG. 3A or 3B. As illustrated, the content obtaining module 106* may include one or more sub-logic modules in various alternative embodiments. For example, in various embodiments, the content obtaining module 106* may include a news content obtaining module 422, a consumable media obtaining module 424, a link obtaining module 426, a content access providing instructions obtaining module 428, a previous consumer information obtaining module 430, a contextual information obtaining module 432, a content presentation option GUI data obtaining module 434, a historical background information presentation option GUI data obtaining module 436, and/or a previous consumer information presentation option GUI data obtaining module 438. Specific details related to the content obtaining module 106*, as well as the above-described sub-modules of the content obtaining module 106*, will be provided below with respect to the operations and processes to be described herein.

A more detailed discussion related to the computing device 10*(e.g., the computing device 10′ of FIG. 3A or the computing device 10″ of FIG. 3B) discussed above will now be provided with respect to the processes and operations to be described herein. FIG. 5 illustrates an operational flow 500 representing example operations for, among other things, receiving content in accordance with a particular level of content access that is associated with a particular amount of content access latency and a particular amount of fee, where the particular level of content access having been selected from a plurality of different and available levels of content access. In various implementations, these operations may be implemented by the computing device 10* of FIG. 3A or 3B (as well as FIG. 1).

In FIG. 5 and in the following figures that include various examples of operational flows, discussions and explanations will be provided with respect to the computing device 10* described above and as illustrated in FIGS. 3A, 3B, 4A, 4B, 4C, and/or with respect to other examples (e.g., as provided in FIGS. 1, 2A, 2B, 2C, 2D, 2E, 2F, 2G, 2H, 2J, 2K, and 2M) and contexts. However, it should be understood that the operational flows may be executed in a number of other environments and contexts, and/or in modified versions of FIGS. 1, 2A, 2B, 2C, 2D, 2E, 2F, 2G, 2H, 2J, 2K, 2M, 3A, 3B, 4A, 4B, and/or 4C. Also, although the various operational flows are presented in the sequence(s) illustrated, it should be understood that the various operations may be performed in other orders other than those which are illustrated, or may be performed concurrently.

Further, in FIG. 5 and in the figures to follow thereafter, various operations may be depicted in a box-within-a-box manner. Such depictions may indicate that an operation in an internal box may comprise an optional example embodiment of the operational step illustrated in one or more external boxes. However, it should be understood that internal box operations may be viewed as independent operations separate from any associated external boxes and may be performed in any sequence with respect to all other illustrated operations, or may be performed concurrently. Still further, these operations illustrated in FIG. 5 as well as the other operations to be described herein are performed by at least one of a machine, an article of manufacture, or a composition of matter unless indicated otherwise.

For ease of understanding, the flowcharts are organized such that the initial flowcharts present implementations via an example implementation and thereafter the following flowcharts present alternate implementations and/or expansions of the initial flowchart(s) as either sub-component operations or additional component operations building on one or more earlier-presented flowcharts. Those having skill in the art will appreciate that the style of presentation utilized herein (e.g., beginning with a presentation of a flowchart(s) presenting an example implementation and thereafter providing additions to and/or further details in subsequent flowcharts) generally allows for a rapid and easy understanding of the various process implementations. In addition, those skilled in the art will further appreciate that the style of presentation used herein also lends itself well to modular and/or object-oriented program design paradigms.

More particularly, in FIG. 5 and in the figures to follow thereafter, various operations may be depicted in a box-within-a-box manner. Such depictions may indicate that an operation in an internal box may comprise an optional example embodiment of the operational step illustrated in one or more external boxes. However, it should be understood that internal box operations may be viewed as independent operations separate from any associated external boxes and may be performed in any sequence with respect to all other illustrated operations, or may be performed concurrently. Still further, these operations illustrated FIG. 5 as well as the other operations to be described herein may be performed by at least one of a machine or an article of manufacture.

In any event, after a start operation, the operational flow 500 of FIG. 5 may move to a bidding tag receiving operation 502 for receiving a bidding tag for a content that is to be offered for consumption at different levels of access for accessing the content, the different levels of access for accessing the content to be offered being associated with different amounts of content access latencies and different amounts of associated fees, and the bidding tag to be received at least identifying a content type to be offered for consumption and designed for eliciting one or more bids for the content. For instance, and as illustration, the bidding tag acquiring module 102* of the computing device 10* of FIG. 3A or 3B (e.g., the bidding tag acquiring module 102′ of FIG. 3A or the bidding tag acquiring module 102″ of FIG. 3B) receiving or acquiring a bidding tag 30 for a content 20 (e.g., news or consumable media) that is to be offered for consumption at different levels of access for accessing the content 20, the different levels of access for accessing the content 20 to be offered for consumption being associated with different amounts of content access latencies (e.g., different amounts of time delays for accessing content 20) and different amounts of associated fees, and the bidding tag 30 to be received at least identifying a content type (e.g., the content type of the content 20) to be offered for consumption and designed for eliciting one or more bids 40 for the content 20.

Operational flow 500 may also include a bid transmitting operation 504 for transmitting a bid in response, at least in part, to receiving the bidding tag, the bid to be transmitted being a request for accessing the content at a particular level of access, the particular level of access being for accessing the content with a particular amount of content access latency and for a particular amount of associated fee, the particular level of access having been selected from the different levels of access for accessing the content. For instance, the bid relaying module 104*(e.g., the bid relaying module 104′ of FIG. 3A or the bid relaying module 104″ of FIG. 3B) of the computing device 10* of FIG. 3A or 3B transmitting (e.g., relaying) a bid 40 in response, at least in part, to receiving the bidding tag 30, the bid 40 to be transmitted being a request for accessing the content 20 at a particular level of access, the requested particular level of access being for accessing the content 20 with a particular amount of content access latency (e.g., a particular amount of delay in accessing the content 20) and for a particular amount of associated fee (e.g., the fee that is associated with the particular amount of content access latency), the particular level of access having been selected from the different levels of access that are available for accessing the content 20.

As further illustrated in FIG. 5, operational flow 500 may also include a content receiving operation 506 for receiving the content in accordance with the particular level of access. For instance, the content obtaining module 106*(e.g., content obtaining module 106′ of FIG. 3A or the content obtaining module 106″ of FIG. 3B) of the computing device 10* of FIG. 3A or 3B receiving (e.g., obtaining) the content 20 (e.g., financial or market news or a consumable media such as a movie) in accordance with the particular level of access. For these implementations, the receiving of the content 20 in accordance with the particular level of access may be in reference to the content 20 being received following lapse of the latency that is associated with the particular level of access.

As will be described below, the bidding tag receiving operation 502, the bid transmitting operation 504, and the content receiving operation 506 may be executed in a variety of different ways in various alternative implementations. FIGS. 6A, 6B, 6C, 6D, 6E, 6F, 6G, and 6H, for example, illustrates at least some of the alternative ways that the bidding tag receiving operation 502 of FIG. 5 may be executed in various alternative implementations. In some cases, for example, the bidding tag receiving operation 502 may include an operation 602 for receiving the bidding tag via one or more wireless and/or wired networks as illustrated in FIG. 6A. For instance, the bidding tag acquiring module 102* of the computing device 10*(e.g., the computing device 10′ of FIG. 3A or the computing device 10″ of FIG. 3B) receiving the bidding tag 30 via one or more wireless and/or wired networks 5 (e.g., cellular data network, WLAN, WiMAX, PTSN, and so forth).

As further illustrated in FIG. 6A, in the same or alternative implementations, the bidding tag receiving operation 502 may additionally or alternative include an operation 603 for receiving the bidding tag from a server. For instance, the bidding tag acquiring module 102* of the computing device 10* of FIG. 3A or 3B receiving the bidding tag from a network server.

In some cases, operation 603 may further include or involve an operation 604 for receiving the bidding tag from a server associated with a content source or a content aggregator. For instance, the bidding tag acquiring module 102* of the computing device 10* of FIG. 3A or 3B receiving the bidding tag 30 from a server associated with a content source (e.g., Nasdaq, Dow Jones, HBO, Warner Brothers, etc.) or a content aggregator (e.g., Google, Yahoo, Market Watch, etc.).

In various embodiments, the bidding tag 30 that may be received may at least identify the type of content 20 to be offered for consumption. For example, in the same or alternative implementations, the bidding tag receiving operation 502 may include or involve an operation 605 for receiving the bidding tag that at least identifies the content type to be offered for consumption by receiving a bidding tag that at least identifies that the content to be offered for consumption is news. For instance, the bidding tag acquiring module 102* of the computing device 10* of FIG. 3A or 3B receiving (e.g., acquiring) the bidding tag 30 that at least identifies the content type to be offered for consumption by receiving (e.g., acquiring) a bidding tag 30 that at least identifies that the content 20 to be offered for consumption is news (e.g., sports news, entertainment news, agricultural news, and so forth). In some cases, the identification of the content 20 may be made by using one or more codes to identity content 20. For example, a digital code such as 0010 may indicate news, while a digital code 0111 may indicate consumable media such as a movie.

As further illustrated in FIG. 6A, operation 605 may include one or more additional operations in various alternative implementations including, in some cases, an operation 606 for receiving the bidding tag that at least identifies the content to be offered for consumption is news by receiving a bidding tag that at least identifies that the content to be offered for consumption is business, financial, and/or market news. For instance, the bidding tag acquiring module 102* of the computing device 10* of FIG. 3A or 3B receiving the bidding tag 30 that at least identifies the content 20 to be offered for consumption is news by receiving a bidding tag 30 that at least identifies that the content 20 to be offered for consumption is or includes business, financial, and/or market news (e.g., price of a particular commodity or stock).

In some implementations, operation 605 may actually include or involve an operation 607 for receiving the bidding tag that at least identifies the content to be offered for consumption is news by receiving a bidding tag that at least identifies that the content to be offered for consumption is human interest news. For instance, the bidding tag acquiring module 102* of the computing device 10* of FIG. 3A or 3B receiving the bidding tag 30 that at least identifies the content 20 to be offered for consumption is news by receiving a bidding tag 30 that at least identifies that the content 20 to be offered for consumption is human interest news (e.g., news related to a particular person or persons such as celebrities, or news related to a natural disaster or a societal event).

In some cases, operation 607 may further include an operation 608 for receiving the bidding tag that at least identifies that the content to be offered for consumption is human interest news by receiving a bidding tag that at least identifies that the content to be offered for consumption is celebrity news. For instance, the bidding tag acquiring module 102* of the computing device 10* of FIG. 3A or 3B receiving the bidding tag 30 that at least identifies that the content 20 to be offered for consumption is human interest news by receiving a bidding tag 30 that at least identifies that the content 20 to be offered for consumption is celebrity news (e.g., identifying that the content is celebrity news related to “Lindsey Lohan”).

In some implementations, operation 605 may actually involve or include an operation 609 for receiving the bidding tag that at least identifies the content to be offered for consumption is news by receiving a bidding tag that at least identifies that the content to be offered for consumption is political, governmental, and/or regulatory news. For instance, the bidding tag acquiring module 102* of the computing device 10* of FIG. 3A or 3B receiving the bidding tag 30 that at least identifies the content 20 to be offered for consumption is news by receiving a bidding tag 30 that at least identifies that the content 20 to be offered for consumption is political, governmental, and/or regulatory news (e.g., news related to interest rates as set forth by the Federal Reserve).

In the same or alternative implementations, the bidding tag receiving operation 502 may additionally or alternatively include an operation 610 for receiving the bidding tag that at least identifies the content type to be offered for consumption by receiving a bidding tag that at least identifies that the content to be offered for consumption is a consumable media. For instance, the bidding tag acquiring module 102* of the computing device 10* of FIG. 3A or 3B receiving the bidding tag 30 that at least identifies the content type to be offered for consumption by receiving (e.g., acquiring) a bidding tag 30 that at least identifies that the content 20 to be offered for consumption is a consumable media (e.g., a recording of a sporting event, a documentary, and so forth).

In some cases, operation 610 may actually include or involve an operation 611 for receiving the bidding tag that at least identifies that the content to be offered for consumption is a consumable media by receiving a bidding tag that at least identifies a name of a textual document, a video, or an audio recording that is included in the content to be offered for consumption. For instance, the bidding tag acquiring module 102* of the computing device 10* of FIG. 3A or 3B receiving the bidding tag 30 that at least identifies that the content 20 to be offered for consumption is a consumable media by receiving a bidding tag 30 that at least identifies a name of a textual document, a video, or an audio recording that is included in the content 20 to be offered for consumption. For example, receiving a bidding tag 30 that indicates the name of a particular feature length movie that is being offered for consumption.

Referring now to FIG. 6B, in various implementations, the bidding tag receiving operation 502 of FIG. 5 may include or involve an operation 612 for receiving the bidding tag for the content that is to be offered for consumption by receiving data that at least facilitates generation of a selection graphical user interface (GUI) that is designed for selecting the particular level of access for accessing the content from the different levels of access for accessing the content. For instance, the bidding tag acquiring module 102* including the selection GUI data acquiring module 402 (see FIG. 4A) of the computing device 10* of FIG. 3A or 3B receiving the bidding tag 30 for the content 20 that is to be offered for consumption when the selection GUI data acquiring module 402 receives (e.g., acquires) data that at least facilitates generation of a selection graphical user interface (selection GUI) that is designed for selecting the particular level of access for accessing the content 20 from the different levels of access for accessing the content 20. Note that in some implementations, the data that is received may comprise the complete or entire data needed for generating the selection GUI (e.g., the selection GUI 200a of FIG. 2A or the selection GUI 200b of FIG. 2B), while in other implementations, the data that is received may only include certain selective information (e.g., latencies, fees, name of content, etc.) that may be needed in order to generate a selection GUI. In some implementations, the data that may be received that at least facilitates generations of the selection GUI may be part of the bidding tag 30 that is received by the computing device 10*.

As further illustrated in FIG. 6B, operation 612 in various implementations may include or involve one or more additional operations including, in some cases, an operation 613 for receiving the data that at least facilitates generation of the selection GUI by receiving data that at least facilitates generation of a selection GUI that includes a slider feature having an elongated element and a slider icon that is designed to be moveable, in response to user input, along length of the elongated element having a first end and a second end at opposite ends of the length of the elongated element, the slider icon being designed to be moved along the length of the elongated element from the first end to the second end to select the level of access for accessing the content. For instance, the selection GUI data acquiring module 402 of the computing device 10* of FIG. 3A or 3B receiving the data that at least facilitates generation of the selection GUI by receiving data that at least facilitates generation of a selection GUI (e.g., selection GUI 200a of FIG. 2A) that includes a slider feature having an elongated element 204a and a slider icon 202a that is designed to be moveable, in response to user input (e.g., user input provided through a touchscreen or by using a mouse), along length of the elongated element 204a having a first end 208a and a second end 210a at opposite ends of the length of the elongated element 204a, the slider icon 202a being designed to be moved along the length of the elongated element 204a from the first end 208a to the second end 210a to select the level of access for accessing the content.

In some implementations, operation 613 may further include an operation 614 for receiving the data that at least facilitates generation of the selection GUI that includes the slider feature having the elongated element and the slider icon that is designed to be moveable, in response to user input, along the length of the elongated element having the first end and the second end by receiving data that at least facilitates generation of a slider feature that includes a slider icon that is designed to be moveable, in response to user input, along length of the elongated element having a first end and a second end and having multiple points along the length of the elongated element including the first end and the second end, the multiple points along the length of the elongated element from the first end to the second end being associated with graduated levels of access for accessing the content with varying amounts of latencies for accessing the content and varying amounts of associated fees, the first end corresponding to highest level of access that is available along the elongated element for accessing the content with lowest amount of latency and highest fee that are available along the elongated element and the second end corresponding to lowest access available along the elongated element for accessing the content with highest amount of latency and lowest fee that are available along the elongated element, and each point along the elongated element from the second end to the first end corresponding to incrementally increasing levels of access for accessing the content with decreasing amounts of latencies and increasing amounts of associated fees. For instance, the selection GUI data acquiring module 402 of the computing device 10* of FIG. 3A or 3B receiving the data that at least facilitates generation of the selection GUI that includes the slider feature 201a (see FIG. 2A) having the elongated element and the slider icon that is designed to be moveable, in response to user input, along the length of the elongated element having the first end and the second end by receiving (e.g., acquiring) data that at least facilitates generation of a slider feature 201a that includes a slider icon 202a that is designed to be moveable, in response to user input, along length of the elongated element 204a having a first end 208a and a second end 210a and having multiple points 212a along the length of the elongated element 204a including the first end 208a and the second end 210a, the multiple points 212a along the length of the elongated element 204a from the first end 208a to the second end 210a being associated with graduated levels of access for accessing the content 20 with varying amounts of latencies for accessing the content 20 and varying amounts of associated fees, the first end 208a corresponding to highest level of access that is available along the elongated element 204a for accessing the content 20 with lowest amount of latency and highest fee that are available along the elongated element 204a and the second end 210a corresponding to lowest access available along the elongated element 204a for accessing the content 20 with highest amount of latency and lowest fee that are available along the elongated element 204a, and each point 212a along the elongated element 204a from the second end 210a to the first end 208a corresponding to incrementally increasing levels of access for accessing the content 20 with decreasing amounts of latencies and increasing amounts of associated fees.

In the same or alternative implementations, operation 613 may additionally or alternatively include an operation 615 for receiving the data that at least facilitates generation of the selection GUI that includes the slider feature having the elongated element and the slider icon that is designed to be moveable, in response to user input, along the length of the elongated element having the first end and the second end by receiving data that at least facilitates generation of a slider feature having an elongated element and a slider icon that is designed to be moveable, in response to user input, along length of the elongated element having at least a first end and a second end and having at least three points along the length of the elongated element including the first end, the second end, and at least a third point between the first end and the second end, each of the at least three points along the length of the elongated element from the first end to the second end being associated with a different level of access for accessing the content with a different amount of latency for accessing the content and different amount of associated fee as illustrated in FIG. 6C. For instance, the selection GUI data acquiring module 402 of the computing device 10* of FIG. 3A or 3B receiving the data that at least facilitates generation of the selection GUI that includes the slider feature having the elongated element and the slider icon that is designed to be moveable, in response to user input, along the length of the elongated element having the first end and the second end by receiving (e.g., acquiring) data that at least facilitates generation of a slider feature 201a (see FIG. 2A) having an elongated element 204a and a slider icon 202a that is designed to be moveable, in response to user input, along length of the elongated element 204a having at least a first end 208a and a second end 210a and having at least three points along the length of the elongated element 204a including the first end 208a, the second end 210a, and at least a third point (e.g., one of the multiple points 212a in FIG. 2A) between the first end 208a and the second end 210a, each of the at least three points along the length of the elongated element 204a from the first end 208a to the second end 210a being associated with a different level of access for accessing the content with a different amount of latency for accessing the content and different amount of associated fee.

As further illustrated in FIG. 6C, operation 615 may, in some implementations, further include an operation 616 for receiving data that at least facilitates generation of a slider feature having an elongated element and a slider icon that is designed to be moveable, in response to user input, along length of the elongated element having at least 10 points along the length of the elongated element including a first end and a second end, each of the at least 10 points along the length of the elongated element from the first end to the second end being associated with a different level of access for accessing the content with a different amount of latency for accessing the content and different amount of associated fee. For instance, the selection GUI data acquiring module 402 of the computing device 10* of FIG. 3A or 3B receiving data that at least facilitates generation of a slider feature 201a (see FIG. 2A) having an elongated element 204a and a slider icon 202a that is designed to be moveable, in response to user input, along length of the elongated element 204a having at least 10 points (e.g., multiple points 212a) along the length of the elongated element 204a including a first end 208a and a second end 210a, each of the at least 10 points (e.g., multiple points 212a) along the length of the elongated element 204a from the first end 208a to the second end 210a being associated with a different level of access for accessing the content 20 with a different amount of latency for accessing the content 20 and different amount of associated fee.

Turning now to FIG. 6D, in some implementations, operation 615 may include an operation 617 for receiving data that at least facilitates generation of a slider feature having an elongated element and a slider icon that is designed to be moveable, in response to user input, along length of the elongated element having at least 30 points along the length of the elongated element including a first end and a second end, each of the at least 30 points along the length of the elongated element from the first end to the second end being associated with a different level of access for accessing the content with a different amount of latency for accessing the content and different amount of associated fee. For instance, the selection GUI data acquiring module 402 of the computing device 10* of FIG. 3A or 3B receiving data that at least facilitates generation of a slider feature 201a (see FIG. 2A) having an elongated element 204a and a slider icon 202a that is designed to be moveable, in response to user input, along length of the elongated element 204a having at least 30 points (e.g., multiple points 212a) along the length of the elongated element 204a including a first end 208a and a second end 210a, each of the at least 30 points (e.g., multiple points 212a) along the length of the elongated element 204a from the first end 208a to the second end 210a being associated with a different level of access for accessing the content with a different amount of latency for accessing the content and different amount of associated fee.

In some implementations, operation 612 for receiving the bidding tag for the content that is to be offered for consumption by receiving data that at least facilitates generation of a selection graphical user interface (GUI) that is designed for selecting the particular level of access for accessing the content from the different levels of access for accessing the content may actually include or involve an operation 618 for receiving the data that at least facilitates generation of a selection GUI by receiving data that at least facilitates generation of a plurality of icons that are designed to be used for selecting a specific level of access for accessing the content from the different levels of access for accessing the content, each of the plurality of icons to be generated being associated with a different level of access for accessing the content with a different amount of latency for accessing the content and different amount of associated fee as illustrated in FIG. 6E. For instance, the selection GUI data acquiring module 402 of the computing device 10* of FIG. 3A or 3B receiving the data that at least facilitates generation of a selection GUI by receiving or acquiring data (e.g., data that is part of the bidding tag 30) that at least facilitates generation of a plurality of icons 220b (see FIG. 2B) that are designed to be used for selecting a specific level of access for accessing the content 20 from the different levels of access for accessing the content, each of the plurality of icons 220b to be generated being associated with a different level of access for accessing the content 20 with a different amount of latency for accessing the content 20 and different amount of associated fee.

As further illustrated in FIG. 6E, in various implementations, operation 618 may actually include or involve one or more additional operations including in some cases an operation 619 for receiving the data that at least facilitates generation of the plurality of icons by receiving data that at least facilitates generation of a plurality of button icons that are designed to be used for selecting the specific level of access for accessing the content from the different levels of access for accessing the content. For instance, the selection GUI data acquiring module 402 of the computing device 10* of FIG. 3A or 3B receiving the data that at least facilitates generation of the plurality of icons by receiving data that at least facilitates generation of a plurality of button icons 200b (see the selection GUI of FIG. 2B) that are designed to be used for selecting the specific level of access for accessing the content 20 from the different levels of access for accessing the content 20 where each icon 220b may be associated with a different level of content access (e.g., different level of content access latency and associated fee).

In some cases, operation 618 may actually involve or include an operation 620 for receiving the data that at least facilitates generation of the plurality of icons by receiving data that at least facilitates generation of at least three icons that are designed to be used for selecting the specific level of access for accessing the content from the different levels of access for accessing the content, each of the at least three icons to be generated being associated with a different level of access for accessing the content with a different amount of latency for accessing the content and different amount of associated fee. For instance, the selection GUI data acquiring module 402 of the computing device 10* of FIG. 3A or 3B receiving the data that at least facilitates generation of the plurality of icons by receiving data that at least facilitates generation of at least three icons 220b (see the selection GUI 200b of FIG. 2B) that are designed to be used for selecting the specific level of access for accessing the content 20 from the different levels of access for accessing the content 20, each of the at least three icons 220b to be generated being associated with a different level of access for accessing the content 20 with a different amount of latency (e.g., time delay) for accessing the content and different amount of associated fee.

In some cases, operation 618 may actually involve or include an operation 621 for receiving the data that at least facilitates generation of the plurality of icons by receiving data that at least facilitates generation of at least ten icons that are designed to be used for selecting the specific level of access for accessing the content from the different levels of access for accessing the content, each of the at least ten icons to be generated being associated with a different level of access for accessing the content with a different amount of latency for accessing the content and different amount of associated fee. For instance, the selection GUI data acquiring module 402 of the computing device 10* of FIG. 3A or 3B receiving the data that at least facilitates generation of the plurality of icons by receiving data that at least facilitates generation of at least ten icons 220b that are designed to be used for selecting the specific level of access for accessing the content 20 from the different levels of access for accessing the content 20, each of the at least ten icons 220b to be generated being associated with a different level of access for accessing the content 20 with a different amount of latency (e.g., no delay, one week, two weeks, and so forth) for accessing the content 20 and different amount of associated fee (e.g., $100, $90, and so forth—the shorter the latency the higher the associated fee).

Turning now to FIG. 6F, in some implementations, operation 612 for receiving the bidding tag for the content that is to be offered for consumption by receiving data that at least facilitates generation of a selection graphical user interface (GUI) that is designed for selecting the particular level of access for accessing the content from the different levels of access for accessing the content may actually include or involve an operation 622 for receiving the data that at least facilitates generation of the selection GUI by receiving data that at least facilitates generation of a selection GUI that includes an option for retrieving and/or presenting contextual information related to the content. For instance, the selection GUI data acquiring module 402 of the computing device 10* of FIG. 3A or 3B receiving the data that at least facilitates generation of the selection GUI by receiving (e.g., acquiring) data that at least facilitates generation of a selection GUI 200a (see FIG. 2A) that includes an option (e.g., icon 209a which may be selected by “tapping” the icon 209a on a touchscreen or “clicking” the icon 209a using a mouse) for retrieving and/or presenting contextual information (e.g., historical market information, movie trailers, etc.) related to the content 20. For example, icon 209a may be tapped or clicked in order to retrieve and/or present historical market data related to content 20 (e.g., market or share price information).

As further illustrated in FIG. 6F, in some cases, operation 622 may actually include or involve an operation 623 for receiving the data that at least facilitates generation of the selection GUI that includes the option for retrieving and/or presenting contextual information related to the content by receiving data that at least facilitates generation of a selection GUI that includes an option for retrieving and/or presenting historical background information related to the content. For instance, the selection GUI data acquiring module 402 of the computing device 10* of FIG. 3A or 3B receiving the data that at least facilitates generation of the selection GUI that includes the option for retrieving and/or presenting contextual information related to the content by receiving data that at least facilitates generation of a selection GUI 200a that includes an option (e.g., icon 209a) for retrieving and/or presenting historical background information (e.g., historical stock market information) related to the content 20 (e.g., stock market news).

In the same or alternative implementations, operation 612 may include an operation 624 for receiving the data that at least facilitates generation of the selection GUI by receiving data that at least facilitates generation of a selection GUI that includes an option for retrieving and/or presenting previous consumer information related to one or more content consumers who have previously accessed the content as further illustrated in FIG. 6F. For instance, the selection GUI data acquiring module 402 of the computing device 10* of FIG. 3A or 3B receiving the data that at least facilitates generation of the selection GUI by receiving (e.g., acquiring) data that at least facilitates generation of a selection GUI 200a that includes an option (e.g., icon 207a which may be selected by “tapping” the icon 207a on a touchscreen or “clicking” the icon 207a using a mouse) for retrieving and/or presenting previous consumer information related to one or more content consumers who have previously accessed the content 20.

In some cases, operation 624 may, in turn, include or involve an operation 625 for receiving the data that at least facilitates generation of the selection GUI that includes an option for retrieving and/or presenting the previous consumer information related to the one or more content consumers who have previously accessed the content by receiving data that at least facilitates generation of a selection GUI that includes an option for retrieving and/or presenting information that identifies the one or more content consumers who have previously accessed the content and/or the number of the one or more content consumers who have previously accessed the content. For instance, the selection GUI data acquiring module 402 of the computing device 10* of FIG. 3A or 3B receiving the data that at least facilitates generation of the selection GUI that includes an option for retrieving and/or presenting the previous consumer information related to the one or more content consumers who have previously accessed the content by receiving data that at least facilitates generation of a selection GUI 200a (see FIG. 2A) that includes an option (e.g., icon 207a) for retrieving and/or presenting information that identifies the one or more content consumers who have previously accessed the content 20 and/or the number of the one or more content consumers who have previously accessed the content 20. For example, identifying which users have already accessed prices of stocks that were disclosed by the content 20 and/or the number of users (e.g., content consumers) who have already viewed such information.

In some implementations, operation 624 may include or involve an operation 626 for receiving the data that at least facilitates generation of the selection GUI that includes an option for retrieving and/or presenting the previous consumer information related to the one or more content consumers who have previously accessed the content by receiving data that at least facilitates generation of a selection GUI that includes an option for retrieving and/or presenting information that indicates when and/or how the one or more content consumers who have previously accessed the content actually accessed the content. For instance, the selection GUI data acquiring module 402 of the computing device 10* of FIG. 3A or 3B receiving the data that at least facilitates generation of the selection GUI that includes an option for retrieving and/or presenting the previous consumer information related to the one or more content consumers who have previously accessed the content by receiving data that at least facilitates generation of a selection GUI 200a that includes an option (e.g., icon 207a) for retrieving and/or presenting information that indicates when and/or how (e.g., what type of communication network or link) the one or more content consumers who have previously accessed the content 20 actually accessed the content 20.

Referring now to FIG. 6G, in some implementations, the bidding tag receiving operation 502 may include or involve an operation 627 for receiving the bidding tag for the content that is to be offered for consumption at different levels of access for accessing the content by receiving data that identifies the different levels of access for accessing the content including identifying for each level of access for accessing the content a corresponding content access latency and associated fee pair. For instance, the bidding tag acquiring module 102* including the access level identifying data acquiring module 404 (see FIG. 4A) of the computing device 10* of FIG. 3A or 3B receiving the bidding tag for the content that is to be offered for consumption at different levels of access for accessing the content when the access level identifying data acquiring module 404 receives (e.g., acquires) data that identifies the different levels of access for accessing the content 20 including identifying for each level of access for accessing the content 20 a corresponding content access latency and associated fee pair (e.g., identifying for a first level of content access a corresponding first content access latency and a first associated fee, identifying for a second level of content access a corresponding second content access latency and a second associated fee, and so forth).

In some implementations, operation 627 may actually include or involve an operation 628 for receiving the data that identifies the different levels of access for accessing the content by receiving data that identifies for at least three different levels of access for accessing the content at least three corresponding content access latency and associated fee pairs. For instance, the access level identifying data acquiring module 404 of the computing device 10* of FIG. 3A or 3B receiving the data that identifies the different levels of access for accessing the content 20 by receiving data that identifies for at least three different levels of access for accessing the content 20 at least three corresponding content access latency and associated fee pairs (e.g., receiving data that identifies for a first level of content access a first latency/fee pair, for a second level of content access a second latency/fee pair, and for a third level of content access a third latency/fee pair.

In other implementations, operation 627 may alternatively include or involve an operation 629 for receiving the data that identifies the different levels of access for accessing the content by receiving data that identifies for at least ten different levels of access for accessing the content at least ten corresponding content access latency and associated fee pairs. For instance, the access level identifying data acquiring module 404 of the computing device 10* of FIG. 3A or 3B receiving the data that identifies the different levels of access for accessing the content 20 by receiving data that identifies for at least ten different levels of access for accessing the content 20 at least ten corresponding content access latency and associated fee pairs.

In some cases, rather than receiving data that specifically identifies the latencies/fees associated with the different levels of content access, alternative data may be received with the bidding tag 30 that provides one or more formulas for generating the different latencies/fees associated with the differing levels of content access that may be made available through a selection GUI (e.g., the selection GUI 200a or selection GUI 200b of FIG. 2A or 2B) that may be presented by the computing device 10* of FIG. 1, 3A, or 3B. For example, in some implementations, the bidding tag receiving operation 502 may additionally or alternatively include an operation 630 for receiving the bidding tag for the content that is to be offered for consumption at different levels of access for accessing the content by receiving data that provides a formula for generating, for each level of access for accessing the content, a corresponding content access latency and associated fee pair. For instance, the bidding tag acquiring module 102* including the formula data acquiring module 406 (see FIG. 4A) of the computing device 10* of FIG. 3A or 3B receiving the bidding tag 30 for the content 20 that is to be offered for consumption at different levels of access for accessing the content 20 when the formula data acquiring module 406 receives (e.g., acquires) data that provides a formula for generating, for each level of access for accessing the content, a corresponding content access latency and associated fee pair. For example, suppose the content 20 to be provided access to is a feature length movie, and there are n^{th} levels of content access available, then formula data could be received that provides the following formulas: latency=1 week *n and Fee=$54/n. Thus, in this example, the greater level of access (e.g., lower n value where n=1 is highest access level) the lower amount of latency and higher fee amount. For example, if n=1, latency would be one week, and the fee would be $54. If n=2, latency will be 2 weeks, and fee would be $27.

In some alternative implementations, the bidding tag receiving operation 502 may alternatively include an operation 631 for receiving the bidding tag for the content that is to be offered for consumption at different levels of access for accessing the content by receiving data that identifies different corresponding content access latencies for each of the different levels of access for accessing the content and data that identifies a formula that when applied to each of the identified corresponding content access latencies generates an associated fee. For instance, the bidding tag acquiring module 102* including the latency data and fee formula data acquiring module 408 (see FIG. 4A) of the computing device 10* of FIG. 3A or 3B receiving the bidding tag 30 for the content 20 that is to be offered for consumption at different levels of access for accessing the content 20 when the latency data and fee formula data acquiring module 408 receives or acquires data that identifies different corresponding content access latencies for each of the different levels of access for accessing the content 20, and data that identifies a formula that when applied to each of the identified corresponding content access latencies generates an associated fee. For example, suppose the content to be accessed is again a movie, then receiving data that indicates that the available latencies are one week, two weeks, three weeks, and so forth, and then receiving data that identifies a formula (e.g., fee=maximum fee/latency) for generating the associated fee for each available latency.

In some alternative implementations, the bidding tag receiving operation 502 may alternatively include an operation 632 for receiving the bidding tag for the content that is to be offered for consumption at different levels of access for accessing the content by receiving data that identifies associated fees for each of the different levels of access for accessing the content and data that identifies a formula that when applied to each of the identified associated fees generates a corresponding content access latency. For instance, the bidding tag acquiring module 102* including the fee data and latency formula data acquiring module 410 (see FIG. 4A) of the computing device 10* of FIG. 3A or 3B receiving the bidding tag 30 for the content 20 that is to be offered for consumption at different levels of access for accessing the content when the fee data and latency formula data acquiring module 410 receives or acquires data that identifies associated fees for each of the different levels of access for accessing the content 20, and data that identifies a formula that when applied to each of the identified associated fees generates a corresponding content access latency. For example, suppose the content to be accessed is again a movie, then receiving data that indicates that the available fees are $54, $27, and so forth, and then receiving data that identifies a formula (e.g., latency=$54/fee) for generating the associated latency for each available fee.

In the same or alternative implementations, the bidding tag receiving operation 502 of FIG. 5 may additionally or alternatively include an operation 633 for receiving the bidding tag for the content that is to be offered for consumption at different levels of access for accessing the content by receiving contextual information related to the content as illustrated in FIG. 6H. For instance, the bidding tag acquiring module 102* including the contextual information acquiring module 412 (see FIG. 4A) of the computing device 10* of FIG. 3A or 3B receiving the bidding tag for the content 20 that is to be offered for consumption at different levels of access for accessing the content when the contextual information acquiring module 412 receives or acquires contextual information (e.g., historical market or financial information or a movie trailer) related to the content 20. In some cases such contextual information may be presented through a selection GUI 200a (e.g., icon 209a may be tapped or clicked in order to view the contextual information through the selection GUI 200 where a pop-up window may be provided to show the contextual information).

In some implementations, operation 633 may actually involve an operation 634 for receiving the contextual information related to the content by receiving historical background information related to the content. For instance, the contextual information acquiring module 412 of the computing device 10* of FIG. 3A or 3B receiving the contextual information related to the content 20 by receiving historical background information (e.g., historical market or financial information) related to the content 20.

In the same or alternative implementations, the bidding tag receiving operation 502 of FIG. 5 may additionally or alternatively include an operation 635 for receiving the bidding tag for the content that is to be offered for consumption at different levels of access for accessing the content by receiving previous consumer information related to one or more content consumers who have previously accessed the content. For instance, the bidding tag acquiring module 102* including the previous consumer information acquiring module 414 (see FIG. 4A) of the computing device 10* of FIG. 3A or 3B receiving the bidding tag 30 for the content 20 that is to be offered for consumption at different levels of access for accessing the content when the previous consumer information acquiring module 414 receives or acquires previous consumer information related to one or more content consumers who have previously accessed the content 20.

As further illustrated in FIG. 6G, in some cases operation 635 may further include or involve an operation 636 for receiving the previous consumer information related to the one or more content consumers who have previously accessed the content by receiving information that identifies the one or more content consumers who have previously accessed the content and/or the number of the one or more content consumers who have previously accessed the content. For instance, the previous consumer information acquiring module 414 of the computing device 10* of FIG. 3A or 3B receiving the previous consumer information related to the one or more content consumers who have previously accessed the content 20 by receiving or acquiring information that identifies the one or more content consumers who have previously accessed the content and/or the number of the one or more content consumers who have previously accessed the content 20.

In the same or alternative implementations, operation 635 may additionally or alternatively include an operation 637 for receiving the previous consumer information related to the one or more content consumers who have previously accessed the content by receiving information that indicates when and/or how the one or more content consumers who have previously accessed the content actually accessed the content. For instance, the previous consumer information acquiring module 414 of the computing device 10* of FIG. 3A or 3B receiving the previous consumer information related to the one or more content consumers who have previously accessed the content 20 by receiving information that indicates when and/or how the one or more content consumers who have previously accessed the content actually accessed the content 20.

Referring back to the bid transmitting operation 504 of FIG. 5, the bid transmitting operation 504 similar to the bidding tag receiving operation 502 of FIG. 5 may be executed in a number of different ways in various alternative embodiments as illustrated in FIGS. 7A, 7B, 7C, 7D, and 7E. In some implementations, for example, the bid transmitting operation 504 may include an operation 738 for transmitting the bid via one or more wireless and/or wired networks as illustrated in FIG. 7A. For instance, the bid relaying module 104* of the computing device 10* of FIG. 3A or 3B transmitting (e.g., relaying) the bid 40 via one or more wireless and/or wired networks 5.

In the same or alternative implementations, the bid transmitting operation 504 may additionally or alternatively include an operation 739 for transmitting the bid to a network device associated with an entity that sent the bidding tag. For instance, the bid relaying module 104* of the computing device 10* of FIG. 3A or 3B transmitting or relaying the bid 40 to a network device (e.g., a network server) associated with an entity that sent the bidding tag 30.

In the same or alternative implementations, the bid transmitting operation 504 may additionally or alternatively include an operation 740 for transmitting the bid to a content source or a content aggregator. For instance, the bid relaying module 104* of the computing device 10* of FIG. 3A or 3B transmitting the bid 40 to a content source 60 (e.g., Dow Jones, Nasdaq, Associated Press, HBO, Warner brothers, and so forth) or a content aggregator 50 (e.g., Google, Yahoo, MSN, MarketWatch, and so forth).

In the same or alternative implementations, the bid transmitting operation 504 may additionally or alternatively include an operation 741 for transmitting the bid that is a request for accessing the content at the particular level of access by transmitting a bid that identifies the content to be accessed. For instance, the bid relaying module 104* of the computing device 10* of FIG. 3A or 3B transmitting the bid 40 that is a request for accessing the content 20 at the particular level of access by transmitting (e.g., relaying) a bid 40 that identifies the content 20 to be accessed. Note that the bid 40 can directly or indirectly identify the content 20 in various alternative implementations. Note that the content 20 may be indirectly identified by using, for example, some sort of code.

In the same or alternative implementations, the bid transmitting operation 504 may additionally or alternatively include an operation 742 for transmitting the bid that is a request for accessing the content at the particular level of access by transmitting a bid that identifies the particular level of access for accessing the content. For instance, the bid relaying module 104* of the computing device 10* of FIG. 3A or 3B transmitting the bid 40 that is a request for accessing the content 20 at the particular level of access by transmitting (e.g., relaying) a bid 40 that identifies the particular level of access (e.g., access level 1, access level 2, and so forth) for accessing the content 20.

In the same or alternative implementations, the bid transmitting operation 504 may additionally or alternatively include an operation 743 for transmitting the bid that is a request for accessing the content at the particular level of access by transmitting a bid that identifies the particular amount of content access latency and the particular amount of associated fee that are associated with the requested particular level of access for accessing the content. For instance, the bid relaying module 104* of the computing device 10* of FIG. 3A or 3B transmitting the bid 40 that is a request for accessing the content 20 at the particular level of access by transmitting (e.g., relaying) a bid 40 that identifies the particular amount of content access latency and the particular amount of associated fee that are associated with the requested particular level of access for accessing the content 20.

Turning now to FIG. 7B, in some implementations, the bid transmitting operation 504 may include an operation 744 for transmitting the bid that is a request for accessing the content at the particular level of access by transmitting a bid that includes a request for contextual data related to the content. For instance, the bid relaying module 104* of the computing device 10* of FIG. 3A or 3B transmitting the bid 40 that is a request for accessing the content 20 at the particular level of access by transmitting (e.g., relaying) a bid 40 that includes a request for contextual data (e.g., historical market data, movie trailers, audio clips, etc.) related to the content 20.

In some cases, operation 744 may further include or involve an operation 745 for transmitting the bid that includes the request for the contextual data related to the content by transmitting a bid that includes a request for historical background information related to the content. For instance, the bid relaying module 104* of the computing device 10* of FIG. 3A or 3B transmitting the bid 40 that includes the request for the contextual data related to the content 20 by transmitting a bid 40 that includes a request for historical background information (e.g., historical market data) related to the content 20 (e.g., stock market or commodity prices for a particular day).

In some implementations, the bid transmitting operation 504 may include an operation 746 for transmitting the bid that is a request for accessing the content at the particular level of access by transmitting a bid that includes a request for previous consumer information related to one or more content consumers who have previously accessed the content. For instance, the bid relaying module 104* of the computing device 10* of FIG. 3A or 3B transmitting the bid 40 that is a request for accessing the content 20 at the particular level of access by transmitting (e.g., relaying) a bid that includes a request for previous consumer information (e.g., content consumer names) related to one or more content consumers who have previously accessed the content 20.

As further illustrated in FIG. 7B, in some implementations, operation 746 may include an operation 747 for transmitting the bid that includes the request for the previous consumer information related to one or more content consumers who have previously accessed the content by transmitting a bid that includes a request for information that identifies the one or more content consumers who have previously accessed the content and/or the number of the one or more content consumers who have previously accessed the content. For instance, the bid relaying module 104* of the computing device 10* of FIG. 3A or 3B transmitting the bid 40 that includes the request for the previous consumer information related to one or more content consumers who have previously accessed the content 20 by transmitting (e.g., relaying) a bid 40 that includes a request for information that identifies the one or more content consumers who have previously accessed the content 20 and/or the number of the one or more content consumers who have previously accessed the content 20.

In the same or different implementations, operation 746 may additionally or alternatively include an operation 748 for transmitting the bid that includes the request for the previous consumer information related to one or more content consumers who have previously accessed the content by transmitting a bid that includes a request for information that indicates when and/or how the one or more content consumers who have previously accessed the content actually accessed the content. For instance, the bid relaying module 104* of the computing device 10* of FIG. 3A or 3B transmitting the bid 40 that includes the request for the previous consumer information related to one or more content consumers who have previously accessed the content 20 by transmitting (e.g., relaying) a bid 40 that includes a request for information that indicates when and/or how the one or more content consumers who have previously accessed the content 20 actually accessed the content 20.

Referring now to FIG. 7C, in some implementations, the bid transmitting operation 504 may include or involve an operation 749 for transmitting the bid in response, at least in part, to receiving the bidding tag by transmitting the bid in response to receiving a user entry that was entered through a selection graphical user interface (GUI) that was generated based, at least in part, on information provided through the bidding tag and designed to be used for selecting a particular level of access for accessing the content from different levels of access for accessing the content, the different levels of access for accessing the content being associated with different amounts of content access latencies and different amounts of associated fees. For instance, the bid relaying module 104* including the user entry responsive bid relaying module 416 (see FIG. 4B) of the computing device 10* of FIG. 3A or 3B transmitting the bid 40 in response, at least in part, to receiving the bidding tag 30 when the user entry responsive bid relaying module 416 transmits (e.g., relays) the bid 40 in response to receiving a user entry (e.g., user input as inputted through a touch screen, a mouse, and so forth) that was entered through a selection graphical user interface (selection GUI 200a of FIG. 2A) that was generated (e.g., as generated by the selection GUI providing module 108*) based, at least in part, on information provided through the bidding tag 30 and designed to be used for selecting a particular level of access for accessing the content 20 from different levels of access for accessing the content 20, the different levels of access for accessing the content 20 being associated with different amounts of content access latencies and different amounts of associated fees.

As further illustrated in FIG. 7C, in some cases, operation 749 may additionally or alternatively include or involve an operation 750 for transmitting the bid in response to receiving the user entry that was entered through the selection GUI by transmitting a bid in response to receiving a user entry that was entered through a selection GUI that includes a slider feature having an elongated element and a slider icon that is designed to be moveable, in response to user input, along length of the elongated element having a first end and a second end at opposite ends of the length of the elongated element, the slider icon being designed to be moved along the length of the elongated element from the first end to the second end to select the particular level of access for accessing the content, the elongated element having multiple points along the length of the elongated element including the first end and the second end, the multiple points along the length of the elongated element from the first end to the second end being associated with graduated levels of access for accessing the content with varying amounts of latencies for accessing the content and varying amounts of associated fees. For instance, the user entry responsive bid relaying module 416 of the computing device 10* of FIG. 3A or 3B transmitting the bid 40 in response to receiving the user entry that was entered through the selection GUI by transmitting a bid 40 in response to receiving a user entry that was entered through a selection GUI 200a (e.g., a selection GUI 200a as provided by selection GUI providing module 108*) that includes a slider feature 201a having an elongated element 204a and a slider icon 202a that is designed to be moveable, in response to user input (e.g., as provided through a touchscreen or a mouse), along length of the elongated element 204a having a first end 208a and a second end 210a at opposite ends of the length of the elongated element 204a, the slider icon 202a being designed to be moved along the length of the elongated element 204a from the first end 208a to the second end 210a to select the particular level of access for accessing the content 20, the elongated element 204a having multiple points 212a along the length of the elongated element 204a including the first end 208a and the second end 210a, the multiple points 212a along the length of the elongated element 204a from the first end 208a to the second end 210a being associated with graduated levels of access for accessing the content 20 with varying amounts of latencies for accessing the content 20 and varying amounts of associated fees.

In some cases, operation 750 may, in turn, further include or involve an operation 751 for transmitting the bid in response to receiving the user entry that was entered through the selection GUI that includes the slider feature having an elongated element and the slider icon by transmitting a bid in response to receiving a user entry that was entered through a selection GUI that includes a slider feature having an elongated element and a slider icon that is designed to be moveable, in response to user input, along length of the elongated element having a first end and a second end at opposite ends of the length of the elongated element, the elongated element having at least three points along the length of the elongated element including the first end and the second end, each of the at least three points along the length of the elongated element from the first end to the second end being associated with a different level of access for accessing the content with a different amount of latency for accessing the content and different amount of associated fee. For instance, the user entry responsive bid relaying module 416 of the computing device 10* of FIG. 3A or 3B transmitting the bid 40 in response to receiving the user entry that was entered through the selection GUI 200a that includes the slider feature 201a having an elongated element 204a and the slider icon 202a by transmitting (e.g., relaying) a bid 40 in response to receiving a user entry that was entered through a selection GUI 200a that includes a slider feature 201a having an elongated element 204a and a slider icon 202a that is designed to be moveable, in response to user input, along length of the elongated element 204a having a first end 208a and a second end 210a at opposite ends of the length of the elongated element 204a, the elongated element 204a having at least three points along the length of the elongated element 204a including the first end 208a and the second end 210a, each of the at least three points along the length of the elongated element 204a from the first end 208a to the second end 210a being associated with a different level of access for accessing the content 20 with a different amount of latency for accessing the content 20 and different amount of associated fee.

Turning now to FIG. 7D, in some implementations, operation 749 may alternatively include or involve an operation 752 for transmitting the bid in response to receiving the user entry that was entered through the selection GUI by transmitting a bid in response to receiving a user entry that was entered through a selection GUI that includes a plurality of icons that are designed to be used for selecting the particular level of access for accessing the content from the different levels of access for accessing the content, each of the plurality of icons that were included in the selection GUI being associated with a different level of access for accessing the content with a different amount of latency for accessing the content and different amount of associated fee. For instance, the user entry responsive bid relaying module 416 of the computing device 10* of FIG. 3A or 3B transmitting the bid 40 in response to receiving the user entry that was entered through the selection GUI by transmitting (e.g., relaying) a bid 40 in response to receiving a user entry that was entered (e.g., as entered through a touchscreen, a mouse, etc.) through a selection GUI 200b (see FIG. 2B) that includes a plurality of icons 220b that are designed to be used for selecting the particular level of access for accessing the content 20 from the different levels of access for accessing the content 20, each of the plurality of icons 220b that were included in the selection GUI 200b being associated with a different level of access for accessing the content 20 with a different amount of latency for accessing the content 20 and different amount of associated fee.

As further illustrated in FIG. 7D, in some implementations, operation 752 may, in turn, further include or involve an operation 753 for transmitting the bid in response to receiving the user entry that was entered through the selection GUI that included the plurality of icons by transmitting a bid in response to receiving a user entry that was entered through a selection GUI that includes at least three icons that are designed to be used for selecting the particular level of access for accessing the content from three different levels of access for accessing the content, each of the at least three icons that were included in the selection GUI being associated with a different level of access for accessing the content with a different amount of latency for accessing the content and different amount of associated fee. For instance, the user entry responsive bid relaying module 416 of the computing device 10* of FIG. 3A or 3B transmitting the bid 40 in response to receiving the user entry that was entered through the selection GUI 200b that included the plurality of icons 220b by transmitting (e.g., relaying) a bid 40 in response to receiving a user entry that was entered through a selection GUI 200b that includes at least three icons 220b that are designed to be used for selecting the particular level of access for accessing the content 20 from three different levels of access for accessing the content 20, each of the at least three icons that were included in the selection GUI 200b being associated with a different level of access for accessing the content 20 with a different amount of latency for accessing the content 20 and different amount of associated fee.

Turning now to FIG. 7E, in some implementations, the bid transmitting operation 504 may include an operation 754 for transmitting the bid including transmitting a request for contextual information related to the content. For instance, the bid relaying module 104* including the contextual information request relaying module 418 (see FIG. 4B) of the computing device 10* of FIG. 3A or 3B transmitting the bid 40 including transmitting or relaying, by the contextual information request relaying module 418, of a request for contextual information related to the content 20.

In some implementations, operation 754 may further include or involve an operation 755 for transmitting the request for the contextual information related to the content by transmitting a request for historical background information related to the content. For instance, the contextual information request relaying module 418 of the computing device 10* of FIG. 3A or 3B transmitting the request for the contextual information related to the content 20 by transmitting (e.g., relaying) a request for historical background information (e.g., historical stock market prices of a particular stock) related to the content 20 (e.g., the stock market price of the particular stock on a particular day).

In the same or alternative implementations, the bid transmitting operation 504 may additionally or alternatively include an operation 756 for transmitting the bid including transmitting a request for previous consumer information related to one or more content consumers who have previously accessed the content. For instance, the bid relaying module 104* including the previous consumer information request relaying module 420 (see FIG. 4B) of the computing device 10* of FIG. 3A or 3B transmitting the bid 40 including transmitting or relaying, by the previous consumer information request relaying module 420, of a request for previous consumer information related to one or more content consumers who have previously accessed the content 20.

In some implementations, operation 756 may actually include or involve an operation 757 for transmitting the request for the previous consumer information related to one or more content consumers who have previously accessed the content by transmitting a request for information that identifies the one or more content consumers who have previously accessed the content and/or the number of the one or more content consumers who have previously accessed the content. For instance, the previous consumer information request relaying module 420 of the computing device 10* of FIG. 3A or 3B transmitting the request for the previous consumer information related to one or more content consumers who have previously accessed the content 20 by transmitting (e.g., relaying) a request for information that identifies the one or more content consumers who have previously accessed the content 20 and/or the number of the one or more content consumers who have previously accessed the content 20.

In the same or alternative implementations, operation 756 may additionally or alternatively include an operation 758 for transmitting the request for the previous consumer information related to one or more content consumers who have previously accessed the content by transmitting a request for information that indicates when and/or how the one or more content consumers who have previously accessed the content actually accessed the content. For instance, the previous consumer information request relaying module 420 of the computing device 10* of FIG. 3A or 3B transmitting the request for the previous consumer information related to one or more content consumers who have previously accessed the content 20 by transmitting (e.g., relaying) a request for information that indicates when and/or how (e.g., speed/bandwidth of the communication links that was used) the one or more content consumers who have previously accessed the content 20 actually accessed the content 20.

Referring back to the content receiving operation 506 of FIG. 5, the content receiving operation 506 similar to the bidding tag receiving operation 502 and the bid transmitting operation 504 of FIG. 5 may be executed in a number of different ways in various alternative embodiments as illustrated in FIGS. 8A, 8B, and 8C. In some implementations, for example, the content receiving operation 506 may include an operation 859 for receiving the content by receiving the content via one or more wireless and/or wired networks as illustrated in FIG. 8A. For instance, the content obtaining module 106* of the computing device 10* of FIG. 3A or 3B receiving the content by receiving (e.g., obtaining) the content 20 via one or more wireless and/or wired networks 5.

In the same or alternative implementations, the content receiving operation 506 may additionally or alternatively include an operation 860 for receiving the content by receiving the content from a server associated with a content source or a content aggregator. For instance, the content obtaining module 106* of the computing device 10* of FIG. 3A or 3B receiving the content 20 by receiving the content 20 from a network server associated with a content source (e.g., Dow Jones, Nasdaq, Associated Press, HBO, Warner brothers, and so forth) or a content aggregator (e.g., Google., Yahoo, MSN, MarketWatch, and so forth).

In the same or alternative implementations, the content receiving operation 506 may additionally or alternatively include an operation 861 for receiving the content by receiving news content. For instance, the content obtaining module 106* including the news content obtaining module 422 (see FIG. 4C) of the computing device 10* of FIG. 3A or 3B receiving the content when the news content obtaining module 422 receives (e.g., obtains) news content (e.g., content related to news).

As further illustrated in FIG. 8A, operation 861 may further include one or more additional operations in various alternative implementations including, in some cases, an operation 862 for receiving the news content by receiving business, financial, and/or market news content. For instance, the news content obtaining module 422 of the computing device 10* of FIG. 3A or 3B receiving the news content by receiving (e.g., obtaining) business, financial, and/or market news content.

In some implementations, operation 861 may actually include or involve an operation 863 for receiving the news content by receiving human interest news content. For instance, the news content obtaining module 422 of the computing device 10* of FIG. 3A or 3B receiving the news content by receiving human interest news content (e.g., content related to natural disasters, societal events, sporting events, or any other news event that may be of interest to the general public).

In some cases, operation 863 may further include an operation 864 for receiving the human interest news content by receiving celebrity news content. For instance, the news content obtaining module 422 of the computing device 10* of FIG. 3A or 3B receiving the human interest news content by receiving celebrity news content (e.g., news related to Lindsey Lohan or Tiger Woods).

In some implementations, operation 861 may include an operation 865 for receiving the news content by receiving political, governmental, and/or regulatory news content. For instance, the news content obtaining module 422 of the computing device 10* of FIG. 3A or 3B receiving the news content by receiving political, governmental, and/or regulatory news content (e.g., content indicating that the Federal Reserve has raised interest rates, or content that indicates that the SEC investigating a Brokerage firm).

Turning now to FIG. 8B, in some implementations, the content receiving operation 506 may include an operation 866 for receiving the content by receiving consumable media. For instance, the content obtaining module 106* including the consumable media obtaining module 424 (see FIG. 4C) of the computing device 10* of FIG. 3A or 3B receiving the content 20 when the consumable media obtaining module 424 receives or obtains consumable media (e.g., an electronic novel, a digital movie, a documentary, a recording of a sporting event, and so forth).

In some cases, operation 866 may actually include or involve an operation 867 for receiving the consumable media by receiving an electronic textual document, a video, or an audio recording. For instance, the consumable media obtaining module 424 of the computing device 10* of FIG. 3A or 3B receiving the consumable media by receiving an electronic textual document (e.g., an electronic novel), a video (e.g., a movie or a television program), or an audio recording (e.g., a soundtrack).

In the same or alternative implementations, the content receiving operation 506 may additionally or alternatively include an operation 868 for receiving the content by receiving a link to access the content. For instance, the content obtaining module 106* including the link obtaining module 426 (see FIG. 4C) of the computing device 10* of FIG. 3A or 3B receiving the content 20 when the link obtaining module 426 receives or obtains a link (e.g., a hyperlink) to access the content 20.

In some cases, operation 868 may further include or involve an operation 869 for receiving the link to access the content including receiving the content in response to a content consumer using the link to retrieve the content. For instance, the link obtaining module 426 (see FIG. 4C) of the computing device 10* of FIG. 3A or 3B receiving the link (e.g., hyperlink) to access the content 20 including receiving the content 20 by the content obtaining module 106* in response to a content consumer using (e.g., “clicking”) the link to retrieve the content 20.

In the same or alternative implementations, the content receiving operation 506 may additionally or alternatively include an operation 870 for receiving the content in accordance with the particular level of access by receiving the content only after a latency associated with the particular level of access has lapsed. For instance, the content obtaining module 106* of the computing device 10* of FIG. 3A or 3B receiving the content 20 in accordance with the particular level of access by receiving or obtaining the content 20 only after a latency (e.g., time delay) associated with the particular level of access has lapsed.

In some cases, operation 870 may actually include or involve an operation 871 for receiving the content only after the latency associated with the particular level of access has lapsed, the lapse of the latency being immediately following earliest point in time in which the content becomes available for consumption. For instance, the content obtaining module 106* of the computing device 10* of FIG. 3A or 3B receiving the content 20 only after the latency associated with the particular level of access has lapsed, the lapse of the latency being immediately following earliest point in time in which the content 20 becomes available for consumption.

In the same or alternative implementations, the content receiving operation 506 may additionally or alternatively include an operation 872 for receiving the content in accordance with the particular level of access by receiving the content prior to lapse of a latency associated with the particular level of access, and receiving one or more instructions to provide access to the content only after the latency has lapsed. For instance, the content obtaining module 106* including the content access providing instructions obtaining module 428 (see FIG. 4C) of the computing device 10* of FIG. 3A or 3B receiving the content 20 in accordance with the particular level of access by receiving the content prior to lapse of a latency associated with the particular level of access, and by having the content access providing instructions obtaining module 428 receive or obtain one or more instructions to provide access to the content 20 only after the latency (e.g., time delay) has lapsed at the computing device 10*.

In the same or alternative implementations, the content receiving operation 506 may additionally or alternatively include an operation 873 for receiving the content including receiving previous consumer information related to one or more content consumers who have previously accessed the content. For instance, the content obtaining module 106* including the previous consumer information obtaining module 430 (see FIG. 4C) of the computing device 10* of FIG. 3A or 3B receiving the content 20 including receiving or obtaining, by the previous consumer information obtaining module 430, of previous consumer information related to one or more content consumers who have previously accessed the content 20.

In some implementations, operation 873 may further include or involve an operation 874 for receiving the previous consumer information related to the one or more content consumers who have previously accessed the content by receiving information that identifies the one or more content consumers who have previously accessed the content and/or the number of the one or more content consumers who have previously accessed the content. For instance, the previous consumer information obtaining module 430 of the computing device 10* of FIG. 3A or 3B receiving the previous consumer information related to the one or more content consumers who have previously accessed the content 20 by receiving or obtaining information that identifies the one or more content consumers who have previously accessed (e.g., viewed and/or heard) the content 20 and/or the number of the one or more content consumers who have previously accessed the content 20.

In the same or alternative implementations, operation 873 may include or involve an operation 875 for receiving the previous consumer information related to the one or more content consumers who have previously accessed the content by receiving information that indicates when and/or how the one or more content consumers who have previously accessed the content actually accessed the content. For instance, the previous consumer information obtaining module 430 of the computing device 10* of FIG. 3A or 3B receiving the previous consumer information related to the one or more content consumers who have previously accessed the content by receiving or obtaining information that indicates when and/or how the one or more content consumers who have previously accessed (e.g., previously viewed and/or heard) the content 20 actually accessed the content 20.

Referring now to FIG. 8C, in some implementations, the content receiving operation 506 may include an operation 876 for receiving the content including receiving contextual information related to the content. For instance, the content obtaining module 106* including the contextual information obtaining module 432 (see FIG. 4C) of the computing device 10* of FIG. 3A or 3B receiving the content 20 including receiving or obtaining, by the contextual information obtaining module 432, of contextual information (e.g., movie trailer, company information, previously published news items, and so forth) related to the content 20.

In some cases, operation 876 may actually include or involve an operation 877 for receiving the contextual information related to the content by receiving historical background information related to the content. For instance, the contextual information obtaining module 432 of the computing device 10* of FIG. 3A or 3B receiving the contextual information related to the content by receiving historical background information (e.g., historical market, business, or financial information) related to the content 20.

In the same or alternative implementations, the content receiving operation 506 may additionally or alternatively include an operation 878 for receiving the content including receiving data that at least facilitates generation of a graphical user interface (GUI) that provides an option for displaying and/or audibly presenting the content. For instance, the content obtaining module 106* including the content presentation option GUI data obtaining module 434 (see FIG. 4C) of the computing device 10* of FIG. 3A or 3B receiving the content 20 including receiving or obtaining, by the content presentation option GUI data obtaining module 434, of data that at least facilitates generation of a graphical user interface (GUI) that provides an option (e.g., icon 220k of FIG. 2K) for displaying and/or audibly presenting the content 20.

In the same or alternative implementations, the content receiving operation 506 may additionally or alternatively include an operation 879 for receiving the content including receiving data that at least facilitates generation of a graphical user interface (GUI) that provides an option for displaying and/or audibly presenting historical background information related to the content. For instance, the content obtaining module 106* including the historical background information presentation option GUI data obtaining module 436 (see FIG. 4C) of the computing device 10* of FIG. 3A or 3B receiving the content 20 including receiving or obtaining, by the historical background information presentation option GUI data obtaining module 436, of data that at least facilitates generation of a graphical user interface (GUI) that provides an option for displaying and/or audibly presenting historical background information related to the content 20.

In the same or alternative implementations, the content receiving operation 506 may additionally or alternatively include an operation 880 for receiving the content including receiving data that at least facilitates generation of a graphical user interface (GUI) that provides an option for displaying and/or audibly presenting previous consumer information related to one or more content consumers who have previously accessed the content. For instance, the content obtaining module 106* including the previous consumer information presentation option GUI data obtaining module 438 (see FIG. 4C) of the computing device 10* of FIG. 3A or 3B receiving the content 20 including receiving or obtaining, by the previous consumer information presentation option GUI data obtaining module 438, of data that at least facilitates generation of a graphical user interface (GUI) that provides an option for displaying and/or audibly presenting previous consumer information related to one or more content consumers who have previously accessed the content 20.

In a general sense, those skilled in the art will recognize that the various aspects described herein which can be implemented, individually and/or collectively, by a wide range of hardware, software, firmware, and/or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, etc.)), and/or electrical circuitry forming a communications device (e.g., a modem, communications switch, optical-electrical equipment, etc.). Those having skill in the art will recognize that the subject matter described herein may be implemented in an analog or digital fashion or some combination thereof.

It has been argued that because high-level programming languages use strong abstraction (e.g., that they may resemble or share symbols with natural languages), they are therefore a “purely mental construct.” (e.g., that “software”—a computer program or computer programming—is somehow an ineffable mental construct, because at a high level of abstraction, it can be conceived and understood in the human mind). This argument has been used to characterize technical description in the form of functions/operations as somehow “abstract ideas.” In fact, in technological arts (e.g., the information and communication technologies) this is not true.

The fact that high-level programming languages use strong abstraction to facilitate human understanding should not be taken as an indication that what is expressed is an abstract idea. In fact, those skilled in the art understand that just the opposite is true. If a high-level programming language is the tool used to implement a technical disclosure in the form of functions/operations, those skilled in the art will recognize that, far from being abstract, imprecise, “fuzzy,” or “mental” in any significant semantic sense, such a tool is instead a near incomprehensibly precise sequential specification of specific computational machines—the parts of which are built up by activating/selecting such parts from typically more general computational machines over time (e.g., clocked time). This fact is sometimes obscured by the superficial similarities between high-level programming languages and natural languages. These superficial similarities also may cause a glossing over of the fact that high-level programming language implementations ultimately perform valuable work by creating/controlling many different computational machines.

The many different computational machines that a high-level programming language specifies are almost unimaginably complex. At base, the hardware used in the computational machines typically consists of some type of ordered matter (e.g., traditional electronic devices (e.g., transistors), deoxyribonucleic acid (DNA), quantum devices, mechanical switches, optics, fluidics, pneumatics, optical devices (e.g., optical interference devices), molecules, etc.) that are arranged to form logic gates. Logic gates are typically physical devices that may be electrically, mechanically, chemically, or otherwise driven to change physical state in order to create a physical reality of Boolean logic.

Logic gates may be arranged to form logic circuits, which are typically physical devices that may be electrically, mechanically, chemically, or otherwise driven to create a physical reality of certain logical functions. Types of logic circuits include such devices as multiplexers, registers, arithmetic logic units (ALUs), computer memory, etc., each type of which may be combined to form yet other types of physical devices, such as a central processing unit (CPU)—the best known of which is the microprocessor. A modern microprocessor will often contain more than one hundred million logic gates in its many logic circuits (and often more than a billion transistors). See, e.g., Wikipedia, Logic gates, http://en.wikipedia.org/wiki/Logic_gates (as of Jun. 5, 2012, 21:03 GMT).

The logic circuits forming the microprocessor are arranged to provide a microarchitecture that will carry out the instructions defined by that microprocessor's defined Instruction Set Architecture. The Instruction Set Architecture is the part of the microprocessor architecture related to programming, including the native data types, instructions, registers, addressing modes, memory architecture, interrupt and exception handling, and external Input/Output. See, e.g., Wikipedia, Computer architecture, http://en.wikipedia.org/wiki/Computer_architecture (as of Jun. 5, 2012, 21:03 GMT).

The Instruction Set Architecture includes a specification of the machine language that can be used by programmers to use/control the microprocessor. Since the machine language instructions are such that they may be executed directly by the microprocessor, typically they consist of strings of binary digits, or bits. For example, a typical machine language instruction might be many bits long (e.g., 32, 64, or 128 bit strings are currently common). A typical machine language instruction might take the form “11110000101011110000111100111111” (a 32 bit instruction).

It is significant here that, although the machine language instructions are written as sequences of binary digits, in actuality those binary digits specify physical reality. For example, if certain semiconductors are used to make the operations of Boolean logic a physical reality, the apparently mathematical bits “1” and “0” in a machine language instruction actually constitute a shorthand that specifies the application of specific voltages to specific wires. For example, in some semiconductor technologies, the binary number “1” (e.g., logical “1”) in a machine language instruction specifies around +5 volts applied to a specific “wire” (e.g., metallic traces on a printed circuit board) and the binary number “0” (e.g., logical “0”) in a machine language instruction specifies around −5 volts applied to a specific “wire.” In addition to specifying voltages of the machines' configuration, such machine language instructions also select out and activate specific groupings of logic gates from the millions of logic gates of the more general machine. Thus, far from abstract mathematical expressions, machine language instruction programs, even though written as a string of zeros and ones, specify many, many constructed physical machines or physical machine states.

Machine language is typically incomprehensible by most humans (e.g., the above example was just ONE instruction, and some personal computers execute more than two billion instructions every second). See, e.g., Wikipedia, Instructions per second, http://en.wikipedia.org/wiki/Instructions_per_second (as of Jun. 5, 2012, 21:04 GMT). Thus, programs written in machine language—which may be tens of millions of machine language instructions long—are incomprehensible. In view of this, early assembly languages were developed that used mnemonic codes to refer to machine language instructions, rather than using the machine language instructions' numeric values directly (e.g., for performing a multiplication operation, programmers coded the abbreviation “mult,” which represents the binary number “011000” in MIPS machine code). While assembly languages were initially a great aid to humans controlling the microprocessors to perform work, in time the complexity of the work that needed to be done by the humans outstripped the ability of humans to control the microprocessors using merely assembly languages.

At this point, it was noted that the same tasks needed to be done over and over, and the machine language necessary to do those repetitive tasks was the same. In view of this, compilers were created. A compiler is a device that takes a statement that is more comprehensible to a human than either machine or assembly language, such as “add 2+2 and output the result,” and translates that human understandable statement into a complicated, tedious, and immense machine language code (e.g., millions of 32, 64, or 128 bit length strings). Compilers thus translate high-level programming language into machine language.

This compiled machine language, as described above, is then used as the technical specification which sequentially constructs and causes the interoperation of many different computational machines such that humanly useful, tangible, and concrete work is done. For example, as indicated above, such machine language—the compiled version of the higher-level language—functions as a technical specification which selects out hardware logic gates, specifies voltage levels, voltage transition timings, etc., such that the humanly useful work is accomplished by the hardware.

Thus, a functional/operational technical description, when viewed by one of skill in the art, is far from an abstract idea. Rather, such a functional/operational technical description, when understood through the tools available in the art such as those just described, is instead understood to be a humanly understandable representation of a hardware specification, the complexity and specificity of which far exceeds the comprehension of most any one human. With this in mind, those skilled in the art will understand that any such operational/functional technical descriptions—in view of the disclosures herein and the knowledge of those skilled in the art—may be understood as operations made into physical reality by (a) one or more interchained physical machines, (b) interchained logic gates configured to create one or more physical machine(s) representative of sequential/combinatorial logic(s), (c) interchained ordered matter making up logic gates (e.g., interchained electronic devices (e.g., transistors), DNA, quantum devices, mechanical switches, optics, fluidics, pneumatics, molecules, etc.) that create physical reality representative of logic(s), or (d) virtually any combination of the foregoing. Indeed, any physical object which has a stable, measurable, and changeable state may be used to construct a machine based on the above technical description. Charles Babbage, for example, constructed the first computer out of wood and powered by cranking a handle.

Thus, far from being understood as an abstract idea, those skilled in the art will recognize a functional/operational technical description as a humanly-understandable representation of one or more almost unimaginably complex and time sequenced hardware instantiations. The fact that functional/operational technical descriptions might lend themselves readily to high-level computing languages (or high-level block diagrams for that matter) that share some words, structures, phrases, etc. with natural language simply cannot be taken as an indication that such functional/operational technical descriptions are abstract ideas, or mere expressions of abstract ideas. In fact, as outlined herein, in the technological arts this is simply not true. When viewed through the tools available to those of skill in the art, such functional/operational technical descriptions are seen as specifying hardware configurations of almost unimaginable complexity.

As outlined above, the reason for the use of functional/operational technical descriptions is at least twofold. First, the use of functional/operational technical descriptions allows near-infinitely complex machines and machine operations arising from interchained hardware elements to be described in a manner that the human mind can process (e.g., by mimicking natural language and logical narrative flow). Second, the use of functional/operational technical descriptions assists the person of skill in the art in understanding the described subject matter by providing a description that is more or less independent of any specific vendor's piece(s) of hardware.

The use of functional/operational technical descriptions assists the person of skill in the art in understanding the described subject matter since, as is evident from the above discussion, one could easily, although not quickly, transcribe the technical descriptions set forth in this document as trillions of ones and zeroes, billions of single lines of assembly-level machine code, millions of logic gates, thousands of gate arrays, or any number of intermediate levels of abstractions. However, if any such low-level technical descriptions were to replace the present technical description, a person of skill in the art could encounter undue difficulty in implementing the disclosure, because such a low-level technical description would likely add complexity without a corresponding benefit (e.g., by describing the subject matter utilizing the conventions of one or more vendor-specific pieces of hardware). Thus, the use of functional/operational technical descriptions assists those of skill in the art by separating the technical descriptions from the conventions of any vendor-specific piece of hardware.

In view of the foregoing, the logical operations/functions set forth in the present technical description are representative of static or sequenced specifications of various ordered-matter elements, in order that such specifications may be comprehensible to the human mind and adaptable to create many various hardware configurations. The logical operations/functions disclosed herein should be treated as such, and should not be disparagingly characterized as abstract ideas merely because the specifications they represent are presented in a manner that one of skill in the art can readily understand and apply in a manner independent of a specific vendor's hardware implementation.

Those having skill in the art will recognize that the state of the art has progressed to the point where there is little distinct ion left between hardware, software, and/or firmware implementations of aspects of systems; the use of hardware, software, and/or firmware is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware in one or more machines, compositions of matter, and articles of manufacture, limited to patentable subject matter under 35 USC 101. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

In some implementations described herein, logic and similar implementations may include software or other control structures. Electronic circuitry, for example, may have one or more paths of electrical current constructed and arranged to implement various functions as described herein. In some implementations, one or more media may be configured to bear a device-detectable implementation when such media hold or transmit device detectable instructions operable to perform as described herein. In some variants, for example, implementations may include an update or modification of existing software or firmware, or of gate arrays or programmable hardware, such as by performing a reception of or a transmission of one or more instructions in relation to one or more operations described herein. Alternatively or additionally, in some variants, an implementation may include special-purpose hardware, software, firmware components, and/or general-purpose components executing or otherwise invoking special-purpose components. Specifications or other implementations may be transmitted by one or more instances of tangible transmission media as described herein, optionally by packet transmission or otherwise by passing through distributed media at various times.

Alternatively or additionally, implementations may include executing a special-purpose instruction sequence or invoking circuitry for enabling, triggering, coordinating, requesting, or otherwise causing one or more occurrences of virtually any functional operations described herein. In some variants, operational or other logical descriptions herein may be expressed as source code and compiled or otherwise invoked as an executable instruction sequence. In some contexts, for example, implementations may be provided, in whole or in part, by source code, such as C++, or other code sequences. In other implementations, source or other code implementation, using commercially available and/or techniques in the art, may be compiled//implemented/translated/converted into a high-level descriptor language (e.g., initially implementing described technologies in C or C++ programming language and thereafter converting the programming language implementation into a logic-synthesizable language implementation, a hardware description language implementation, a hardware design simulation implementation, and/or other such similar mode(s) of expression). For example, some or all of a logical expression (e.g., computer programming language implementation) may be manifested as a Verilog-type hardware description (e.g., via Hardware Description Language (HDL) and/or Very High Speed Integrated Circuit Hardware Descriptor Language (VHDL)) or other circuitry model which may then be used to create a physical implementation having hardware (e.g., an Application Specific Integrated Circuit). Those skilled in the art will recognize how to obtain, configure, and optimize suitable transmission or computational elements, material supplies, actuators, or other structures in light of these teachings.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.).

It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

This application may make reference to one or more trademarks, e.g., a word, letter, symbol, or device adopted by one manufacturer or merchant and used to identify and/or distinguish his or her product from those of others. Trademark names used herein are set forth in such language that makes clear their identity, that distinguishes them from common descriptive nouns, that have fixed and definite meanings, or, in many if not all cases, are accompanied by other specific identification using terms not covered by trademark. In addition, trademark names used herein have meanings that are well-known and defined in the literature, or do not refer to products or compounds for which knowledge of one or more trade secrets is required in order to divine their meaning. All trademarks referenced in this application are the property of their respective owners, and the appearance of one or more trademarks in this application does not diminish or otherwise adversely affect the validity of the one or more trademarks. All trademarks, registered or unregistered, that appear in this application are assumed to include a proper trademark symbol, e.g., the circle R or bracketed capitalization (e.g., [trademark name]), even when such trademark symbol does not explicitly appear next to the trademark. To the extent a trademark is used in a descriptive manner to refer to a product or process, that trademark should be interpreted to represent the corresponding product or process as of the date of the filing of this patent application.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

1. A computationally-implemented method, comprising:
receiving a bidding tag for a content that is to be offered for consumption at different levels of access for accessing the content, the different levels of access for accessing the content to be offered being associated with different amounts of content access latencies and different amounts of associated fees, and the bidding tag to be received at least identifying a content type to be offered for consumption and designed for eliciting one or more bids for the content;
transmitting a bid in response, at least in part, to receiving the bidding tag, the bid to be transmitted being a request for accessing the content at a particular level of access, the particular level of access being for accessing the content with a particular amount of content access latency and for a particular amount of associated fee, the particular level of access having been selected from the different levels of access for accessing the content; and
receiving the content in accordance with the particular level of access.

2.-80. (canceled)

81. A computationally-implemented system, comprising:
means for receiving a bidding tag for a content that is to be offered for consumption at different levels of access for accessing the content, the different levels of access for accessing the content to be offered being associated with different amounts of content access latencies and different amounts of associated fees, and the bidding tag to be received at least identifying a content type to be offered for consumption and designed for eliciting one or more bids for the content;
means for transmitting a bid in response, at least in part, to receiving the bidding tag, the bid to be transmitted being a request for accessing the content at a particular level of access, the particular level of access being for accessing the content with a particular amount of content access latency and for a particular amount of associated fee, the particular level of access having been selected from the different levels of access for accessing the content; and
means for receiving the content in accordance with the particular level of access.

82. (canceled)

83. (canceled)

84. (canceled)

85. (canceled)

86. (canceled)

87. (canceled)

88. (canceled)

89. (canceled)

90. (canceled)

91. (canceled)

92. The computationally-implemented system of claim 81, wherein said means for receiving a bidding tag for a content that is to be offered for consumption at different levels of access for accessing the content, the different levels of access for accessing the content to be offered being associated with different amounts of content access latencies and different amounts of associated fees, and the bidding tag to be received at least identifying a content type to be offered for consumption and designed for eliciting one or more bids for the content comprises:
means for receiving the bidding tag for the content that is to be offered for consumption by receiving data that at least facilitates generation of a selection graphical user interface (GUI) that is designed for selecting the particular level of access for accessing the content from the different levels of access for accessing the content.

93. The computationally-implemented system of claim 92, wherein said means for receiving the bidding tag for the content that is to be offered for consumption by receiving data that at least facilitates generation of a selection graphical user interface (GUI) that is designed for selecting the particular level of access for accessing the content from the different levels of access for accessing the content comprises:
means for receiving the data that at least facilitates generation of the selection GUI by receiving data that at least facilitates generation of a selection GUI that includes a slider feature having an elongated element and a slider icon that is designed to be moveable, in response to user input, along length of the elongated element having a first end and a second end at opposite ends of the length of the elongated element, the slider icon being designed to be moved along the length of the elongated element from the first end to the second end to select the level of access for accessing the content.

94. (canceled)

95. (canceled)

96. (canceled)

97. (canceled)

98. The computationally-implemented system of claim 92, wherein said means for receiving the bidding tag for the content that is to be offered for consumption by receiving data that at least facilitates generation of a selection graphical user interface (GUI) that is designed for selecting the particular level of access for accessing the content from the different levels of access for accessing the content comprises:
means for receiving the data that at least facilitates generation of a selection GUI by receiving data that at least facilitates generation of a plurality of icons that are designed to be used for selecting a specific level of access for accessing the content from the different levels of access for accessing the content, each of the plurality of icons to be generated being associated with a different level of access for accessing the content with a different amount of latency for accessing the content and different amount of associated fee.

99. (canceled)

100. (canceled)

101. (canceled)

102. (canceled)

103. (canceled)

104. (canceled)

105. (canceled)

106. (canceled)

107. The computationally-implemented system of claim 81, wherein said means for receiving a bidding tag for a content that is to be offered for consumption at different levels of access for accessing the content, the different levels of access for accessing the content to be offered being associated with different amounts of content access latencies and different amounts of associated fees, and the bidding tag to be received at least identifying a content type to be offered for consumption and designed for eliciting one or more bids for the content comprises:
means for receiving the bidding tag for the content that is to be offered for consumption at different levels of access for accessing the content by receiving data that identifies the different levels of access for accessing the content including identifying for each level of access for accessing the content a corresponding content access latency and associated fee pair.

108. The computationally-implemented system of claim 107, wherein said means for receiving the bidding tag for the content that is to be offered for consumption at different levels of access for accessing the content by receiving data that identifies the different levels of access for accessing the content including identifying for each level of access for accessing the content a corresponding content access latency and associated fee pair comprises:
means for receiving the data that identifies the different levels of access for accessing the content by receiving data that identifies for at least three different levels of access for accessing the content at least three corresponding content access latency and associated fee pairs.

109. (canceled)

110. The computationally-implemented system of claim 81, wherein said means for receiving a bidding tag for a content that is to be offered for consumption at different levels of access for accessing the content, the different levels of access for accessing the content to be offered being associated with different amounts of content access latencies and different amounts of associated fees, and the bidding tag to be received at least identifying a content type to be offered for consumption and designed for eliciting one or more bids for the content comprises:
means for receiving the bidding tag for the content that is to be offered for consumption at different levels of access for accessing the content by receiving data that provides a formula for generating, for each level of access for accessing the content, a corresponding content access latency and associated fee pair.

111. The computationally-implemented system of claim 81, wherein said means for receiving a bidding tag for a content that is to be offered for consumption at different levels of access for accessing the content, the different levels of access for accessing the content to be offered being associated with different amounts of content access latencies and different amounts of associated fees, and the bidding tag to be received at least identifying a content type to be offered for consumption and designed for eliciting one or more bids for the content comprises:
means for receiving the bidding tag for the content that is to be offered for consumption at different levels of access for accessing the content by receiving data that identifies different corresponding content access latencies for each of the different levels of access for accessing the content and data that identifies a formula that when applied to each of the identified corresponding content access latencies generates an associated fee.

112. The computationally-implemented system of claim 81, wherein said means for receiving a bidding tag for a content that is to be offered for consumption at different levels of access for accessing the content, the different levels of access for accessing the content to be offered being associated with different amounts of content access latencies and different amounts of associated fees, and the bidding tag to be received at least identifying a content type to be offered for consumption and designed for eliciting one or more bids for the content comprises:
means for receiving the bidding tag for the content that is to be offered for consumption at different levels of access for accessing the content by receiving data that identifies associated fees for each of the different levels of access for accessing the content and data that identifies a formula that when applied to each of the identified associated fees generates a corresponding content access latency.

113. (canceled)

114. (canceled)

115. The computationally-implemented system of claim 81, wherein said means for receiving a bidding tag for a content that is to be offered for consumption at different levels of access for accessing the content, the different levels of access for accessing the content to be offered being associated with different amounts of content access latencies and different amounts of associated fees, and the bidding tag to be received at least identifying a content type to be offered for consumption and designed for eliciting one or more bids for the content comprises:
means for receiving the bidding tag for the content that is to be offered for consumption at different levels of access for accessing the content by receiving previous consumer information related to one or more content consumers who have previously accessed the content.

116. The computationally-implemented system of claim 115, wherein said means for receiving the bidding tag for the content that is to be offered for consumption at different levels of access for accessing the content by receiving previous consumer information related to one or more content consumers who have previously accessed the content comprises:
means for receiving the previous consumer information related to the one or more content consumers who have previously accessed the content by receiving information that identifies the one or more content consumers who have previously accessed the content and/or the number of the one or more content consumers who have previously accessed the content.

117. The computationally-implemented system of claim 115, wherein said means for receiving the bidding tag for the content that is to be offered for consumption at different levels of access for accessing the content by receiving previous consumer information related to one or more content consumers who have previously accessed the content comprises:
means for receiving the previous consumer information related to the one or more content consumers who have previously accessed the content by receiving information that indicates when and/or how the one or more content consumers who have previously accessed the content actually accessed the content.

118. (canceled)

119. (canceled)

120. (canceled)

121. (canceled)

122. (canceled)

123. The computationally-implemented system of claim 81, wherein said means for transmitting a bid in response, at least in part, to receiving the bidding tag, the bid to be transmitted being a request for accessing the content at a particular level of access, the particular level of access being for accessing the content with a particular amount of content access latency and for a particular amount of associated fee, the particular level of access having been selected from the different levels of access for accessing the content comprises:
means for transmitting the bid that is a request for accessing the content at the particular level of access by transmitting a bid that identifies the particular amount of content access latency and the particular amount of associated fee that are associated with the requested particular level of access for accessing the content.

124. (canceled)

125. (canceled)

126. (canceled)

127. (canceled)

128. (canceled)

129. The computationally-implemented system of claim 81, wherein said means for transmitting a bid in response, at least in part, to receiving the bidding tag, the bid to be transmitted being a request for accessing the content at a particular level of access, the particular level of access being for accessing the content with a particular amount of content access latency and for a particular amount of associated fee, the particular level of access having been selected from the different levels of access for accessing the content comprises:
means for transmitting the bid in response, at least in part, to receiving the bidding tag by transmitting the bid in response to receiving a user entry that was entered through a selection graphical user interface (GUI) that was generated based, at least in part, on information provided through the bidding tag and designed to be used for selecting a particular level of access for accessing the content from different levels of access for accessing the content, the different levels of access for accessing the content being associated with different amounts of content access latencies and different amounts of associated fees.

130. The computationally-implemented system of claim 129, wherein said means for transmitting the bid in response, at least in part, to receiving the bidding tag by transmitting the bid in response to receiving a user entry that was entered through a selection graphical user interface (GUI) that was generated based, at least in part, on information provided through the bidding tag and designed to be used for selecting a particular level of access for accessing the content from different levels of access for accessing the content, the different levels of access for accessing the content being associated with different amounts of content access latencies and different amounts of associated fees comprises:
means for transmitting the bid in response to receiving the user entry that was entered through the selection GUI by transmitting a bid in response to receiving a user entry that was entered through a selection GUI that includes a slider feature having an elongated element and a slider icon that is designed to be moveable, in response to user input, along length of the elongated element having a first end and a second end at opposite ends of the length of the elongated element, the slider icon being designed to be moved along the length of the elongated element from the first end to the second end to select the particular level of access for accessing the content, the elongated element having multiple points along the length of the elongated element including the first end and the second end, the multiple points along the length of the elongated element from the first end to the second end being associated with graduated levels of access for accessing the content with varying amounts of latencies for accessing the content and varying amounts of associated fees.

131. The computationally-implemented system of claim 130, wherein said means for transmitting the bid in response to receiving the user entry that was entered through the selection GUI by transmitting a bid in response to receiving a user entry that was entered through a selection GUI that includes a slider feature having an elongated element and a slider icon that is designed to be moveable, in response to user input, along length of the elongated element having a first end and a second end at opposite ends of the length of the elongated element, the slider icon being designed to be moved along the length of the elongated element from the first end to the second end to select the particular level of access for accessing the content, the elongated element having multiple points along the length of the elongated element including the first end and the second end, the multiple points along the length of the elongated element from the first end to the second end being associated with graduated levels of access for accessing the content with varying amounts of latencies for accessing the content and varying amounts of associated fees comprises:
means for transmitting the bid in response to receiving the user entry that was entered through the selection GUI that includes the slider feature having an elongated element and the slider icon by transmitting a bid in response to receiving a user entry that was entered through a selection GUI that includes a slider feature having an elongated element and a slider icon that is designed to be moveable, in response to user input, along length of the elongated element having a first end and a second end at opposite ends of the length of the elongated element, the elongated element having at least three points along the length of the elongated element including the first end and the second end, each of the at least three points along the length of the elongated element from the first end to the second end being associated with a different level of access for accessing the content with a different amount of latency for accessing the content and different amount of associated fee.

132. The computationally-implemented system of claim 129, wherein said means for transmitting the bid in response, at least in part, to receiving the bidding tag by transmitting the bid in response to receiving a user entry that was entered through a selection graphical user interface (GUI) that was generated based, at least in part, on information provided through the bidding tag and designed to be used for selecting a particular level of access for accessing the content from different levels of access for accessing the content, the different levels of access for accessing the content being associated with different amounts of content access latencies and different amounts of associated fees comprises:
means for transmitting the bid in response to receiving the user entry that was entered through the selection GUI by transmitting a bid in response to receiving a user entry that was entered through a selection GUI that includes a plurality of icons that are designed to be used for selecting the particular level of access for accessing the content from the different levels of access for accessing the content, each of the plurality of icons that were included in the selection GUI being associated with a different level of access for accessing the content with a different amount of latency for accessing the content and different amount of associated fee.

133. The computationally-implemented system of claim 132, wherein said means for transmitting the bid in response to receiving the user entry that was entered through the selection GUI by transmitting a bid in response to receiving a user entry that was entered through a selection GUI that includes a plurality of icons that are designed to be used for selecting the particular level of access for accessing the content from the different levels of access for accessing the content, each of the plurality of icons that were included in the selection GUI being associated with a different level of access for accessing the content with a different amount of latency for accessing the content and different amount of associated fee comprises:
means for transmitting the bid in response to receiving the user entry that was entered through the selection GUI that included the plurality of icons by transmitting a bid in response to receiving a user entry that was entered through a selection GUI that includes at least three icons that are designed to be used for selecting the particular level of access for accessing the content from three different levels of access for accessing the content, each of the at least three icons that were included in the selection GUI being associated with a different level of access for accessing the content with a different amount of latency for accessing the content and different amount of associated fee.

134. The computationally-implemented system of claim 81, wherein said means for transmitting a bid in response, at least in part, to receiving the bidding tag, the bid to be transmitted being a request for accessing the content at a particular level of access, the particular level of access being for accessing the content with a particular amount of content access latency and for a particular amount of associated fee, the particular level of access having been selected from the different levels of access for accessing the content comprises:
means for transmitting the bid including transmitting a request for contextual information related to the content.

135. The computationally-implemented system of claim 134, wherein said means for transmitting the bid including transmitting a request for contextual information related to the content comprises:
means for transmitting the request for the contextual information related to the content by transmitting a request for historical background information related to the content.

136. The computationally-implemented system of claim 81, wherein said means for transmitting a bid in response, at least in part, to receiving the bidding tag, the bid to be transmitted being a request for accessing the content at a particular level of access, the particular level of access being for accessing the content with a particular amount of content access latency and for a particular amount of associated fee, the particular level of access having been selected from the different levels of access for accessing the content comprises:
means for transmitting the bid including transmitting a request for previous consumer information related to one or more content consumers who have previously accessed the content.

137. The computationally-implemented system of claim 136, wherein said means for transmitting the bid including transmitting a request for previous consumer information related to one or more content consumers who have previously accessed the content comprises:
means for transmitting the request for the previous consumer information related to one or more content consumers who have previously accessed the content by transmitting a request for information that identifies the one or more content consumers who have previously accessed the content and/or the number of the one or more content consumers who have previously accessed the content.

138. The computationally-implemented system of claim 136, wherein said means for transmitting the bid including transmitting a request for previous consumer information related to one or more content consumers who have previously accessed the content comprises:
means for transmitting the request for the previous consumer information related to one or more content consumers who have previously accessed the content by transmitting a request for information that indicates when and/or how the one or more content consumers who have previously accessed the content actually accessed the content.

139. (canceled)

140. (canceled)

141. The computationally-implemented system of claim 81, wherein said means for receiving the content in accordance with the particular level of access comprises:
means for receiving the content by receiving news content.

142. The computationally-implemented system of claim 141, wherein said means for receiving the content by receiving news content comprises:
means for receiving the news content by receiving business, financial, and/or market news content.

143. (canceled)

144. (canceled)

145. The computationally-implemented system of claim 141, wherein said means for receiving the content by receiving news content comprises:
means for receiving the news content by receiving political, governmental, and/or regulatory news content.

146. The computationally-implemented system of claim 81, wherein said means for receiving the content in accordance with the particular level of access comprises:
means for receiving the content by receiving consumable media.

147. The computationally-implemented system of claim 146, wherein said means for receiving the content by receiving consumable media comprises:
means for receiving the consumable media by receiving an electronic textual document, a video, or an audio recording.

148. The computationally-implemented system of claim 81, wherein said means for receiving the content in accordance with the particular level of access comprises:
means for receiving the content by receiving a link to access the content.

149. The computationally-implemented system of claim 148, wherein said means for receiving the content by receiving a link to access the content comprises:
means for receiving the link to access the content including receiving the content in response to a content consumer using the link to retrieve the content.

150. The computationally-implemented system of claim 81, wherein said means for receiving the content in accordance with the particular level of access comprises:
means for receiving the content in accordance with the particular level of access by receiving the content only after a latency associated with the particular level of access has lapsed.

151. The computationally-implemented system of claim 150, wherein said means for receiving the content in accordance with the particular level of access by receiving the content only after a latency associated with the particular level of access has lapsed comprises:
means for receiving the content only after the latency associated with the particular level of access has lapsed, the lapse of the latency being immediately following earliest point in time in which the content becomes available for consumption.

152. The computationally-implemented system of claim 81, wherein said means for receiving the content in accordance with the particular level of access comprises:
means for receiving the content in accordance with the particular level of access by receiving the content prior to lapse of a latency associated with the particular level of access, and receiving one or more instructions to provide access to the content only after the latency has lapsed.

153. The computationally-implemented system of claim 81, wherein said means for receiving the content in accordance with the particular level of access comprises:
means for receiving the content including receiving previous consumer information related to one or more content consumers who have previously accessed the content.

154. The computationally-implemented system of claim 153, wherein said means for receiving the content including receiving previous consumer information related to one or more content consumers who have previously accessed the content comprises:
means for receiving the previous consumer information related to the one or more content consumers who have previously accessed the content by receiving information that identifies the one or more content consumers who have previously accessed the content and/or the number of the one or more content consumers who have previously accessed the content.

155. The computationally-implemented system of claim 153, wherein said means for receiving the content including receiving previous consumer information related to one or more content consumers who have previously accessed the content comprises:
means for receiving the previous consumer information related to the one or more content consumers who have previously accessed the content by receiving information that indicates when and/or how the one or more content consumers who have previously accessed the content actually accessed the content.

156. The computationally-implemented system of claim 81, wherein said means for receiving the content in accordance with the particular level of access comprises:
means for receiving the content including receiving contextual information related to the content.

157. The computationally-implemented system of claim 156, wherein said means for receiving the content including receiving contextual information related to the content comprises:
means for receiving the contextual information related to the content by receiving historical background information related to the content.

158. (canceled)

159. (canceled)

160. (canceled)

161. A system, comprising:
circuitry for receiving a bidding tag for a content that is to be offered for consumption at different levels of access for accessing the content, the different levels of access for accessing the content to be offered being associated with different amounts of content access latencies and different amounts of associated fees, and the bidding tag to be received at least identifying a content type to be offered for consumption and designed for eliciting one or more bids for the content;
circuitry for transmitting a bid in response, at least in part, to receiving the bidding tag, the bid to be transmitted being a request for accessing the content at a particular level of access, the particular level of access being for accessing the content with a particular amount of content access latency and for a particular amount of associated fee, the particular level of access having been selected from the different levels of access for accessing the content; and
circuitry for receiving the content in accordance with the particular level of access.
